(19) United States
(12) Patent Application Publication
(10) Pub. No.: US 2026/0250129 A1
(43) Pub. Date: Aug. 27, 2026

(54) CARBON FORMATION CHEMICAL LOOPING USING OXYGEN

(71) Applicant: CZERO, INC., Goleta, CA (US)

(72) Inventors: Samuel SHANER, Goleta, CA (US); Steve CALDERONE, Goleta, CA (US); Philip PIPER, Goleta, CA (US); Eric W. McFARLAND, Goleta, CA (US); Brett PARKINSON, Goleta, CA (US)

(21) Appl. No.: 18/992,816

(22) PCT Filed: Jul. 10, 2023
(86) PCT No.: PCT/US2023/027281

§ 371 Date: Jan. 9, 2025

Related U.S. Application Data
(60) Provisional application No. 63/359,858, filed on Jul. 10, 2022.
(60) Provisional application No. 63/374,844, filed on Sep. 7, 2022.
(60) Provisional application No. 63/387,249, filed on Dec. 13, 2022.

(51) Int. Cl. C01B 3/48; C01B 3/26; C01B 3/36; C01B 32/40

(52) U.S. Cl. CPC C01B 3/48; C01B 3/26; C01B 3/36; C01B 32/40; C01B 2203/0233; C01B 2203/0255; C01B 2203/0277; C01B 2203/0283; C01B 2203/047; C01B 2203/048; C01B 2203/0495; C01B 2203/148

(57) ABSTRACT

A process for reacting of a hydrocarbon includes reacting a hydrocarbon with oxygen to produce a gas stream and a solid stream in a reactor, and separating the gas stream from the solid stream. The gas stream includes hydrogen, water, and carbon oxides, and the solid stream comprises solid carbon.

### CROSS-REFERENCE TO RELATED APPLICATIONS

The present application claims priority to: 1) U.S. Provisional Patent Application No. 63/359,858 filed on Jul. 10, 2022 and entitled, “CARBON FORMATION CHEMICAL LOOPING USING OXYGEN”, 2) U.S. Provisional Patent Application No. 63/374,844 filed on Sep. 7, 2022 and entitled, “CARBON FORMATION CHEMICAL LOOPING USING OXYGEN”, and 3) U.S. Provisional Patent Application No. 63/387,249 filed on Dec. 13, 2022 and entitled, “CARBON FORMATION CHEMICAL LOOPING USING OXYGEN”, all of which are incorporated herein by reference in their entirety.

### STATEMENT REGARDING GOVERNMENTALLY SPONSORED RESEARCH OR DEVELOPMENT

None.

### BACKGROUND

Industrial hydrogen can be produced primarily by reacting hydrocarbon feedstocks (e.g. CH₄, naphtha, biomass, coal, etc) with oxygen-containing species (e.g. O₂, H₂O, CO₂) to produce a desired mixture of H₂, CO₂, and H₂O. Overall the carbon input to the system exits as CO₂, which is typically released to the environment or, in future scenarios, geologically sequestered. This results in significant additional costs resulting from CO₂ handling and sequestration process costs, a carbon tax, or a negative externality on society (e.g., climate change).

### SUMMARY

In some embodiments, a process for reacting of a hydrocarbon comprises reacting a hydrocarbon with oxygen to produce a gas stream and a solid stream in a reactor, and separating the gas stream from the solid stream. The gas stream comprises hydrogen, water, and carbon oxides, and the solid stream comprises solid carbon.

In some embodiments, a process for reacting of a hydrocarbon comprises reacting a hydrocarbon with one or more oxygen-containing species in a first reactor to produce a first product stream comprising hydrogen, water, and carbon oxides, separating water from the first product stream, reacting the hydrogen and carbon oxides in a second reactor to produce a second product stream of solid carbon, water, hydrogen, and carbon oxides, separating the solid carbon from the hydrogen, water, and carbon oxides, and separating the water from the hydrogen and carbon oxides.

In some embodiments, a reaction process for producing hydrogen and carbon comprises introducing a feed stream comprising a hydrocarbon and an oxidant into a reactor system, producing H₂ and solid carbon as products in the reactor system, separating the solid carbon and the H₂ from the one or more reactors, and recycling at least a portion of any unreacted hydrocarbon and the oxidant to an inlet of the reactor system. The reactor system can comprise one or more reactors.

In some embodiments, a system for producing hydrogen and carbon comprises one or more reactors, a feed stream comprising a hydrocarbon, an oxidant, a solid carbon product, and a hydrogen gas product. The reactor is configured to receive the feed stream and the oxidant and react the hydrocarbon and the oxidant to produce the solid carbon product and the hydrogen gas product.

In some embodiments, a process for reacting of carbon monoxide and hydrogen comprises reacting a feed stream in contact with a solid phase comprising catalyst and carbon in a reactor to produce a product stream comprising hydrogen, carbon monoxide, carbon dioxide, water, and solid carbon, separating a solids stream comprising catalyst and carbon from the product stream to produce a gas stream comprising hydrogen, carbon monoxide, carbon dioxide, and water, cooling the gas stream in a heat exchanger, and separating water from the gas stream after the cooling to produce a dehydrated stream comprising hydrogen, carbon monoxide, and carbon dioxide. The feed stream comprises carbon monoxide and hydrogen.

In some embodiments, a multiphase reaction process comprises reacting a feed stream comprising hydrogen and carbon monoxide to form a gas stream comprising hydrogen, carbon monoxide, and carbon dioxide, and forming a solid phase comprising carbon on the catalyst. The reacting occurs in the presence of a catalyst in a reactor.

### BRIEF DESCRIPTION OF THE DRAWINGS

For a more complete understanding of the present disclosure, reference is now made to the following brief description, taken in connection with the accompanying drawings and detailed description:

FIG. 1 schematically illustrates a carbon formation system according to some embodiments.

FIG. 2 schematically illustrates the conversion of a hydrocarbon to solid carbon on a solid catalyst within a carbon formation reaction according to some embodiments.

FIG. 3 schematically illustrates another carbon formation system according to some embodiments.

FIG. 4 schematically illustrates still another carbon formation system according to some embodiments.

FIG. 5 schematically illustrates the conversion of a hydrocarbon to solid carbon on a catalyst with Boudouard, CO reduction, and pyrolysis reactions according to some embodiments.

FIG. 6 schematically illustrates a system for producing hydrogen and solid carbon according to some embodiments.

FIG. 7 illustrates another system for producing hydrogen and solid carbon according to some embodiments.

FIG. 8 illustrates still another system for producing hydrogen and solid carbon according to some embodiments.

FIG. 9 illustrates a carbon formation reactor according to some embodiments.

FIG. 10 schematically illustrates the attrition of catalyst and solid carbon according to some embodiments.

FIG. 11 illustrates the exemplary test setup used for Example 1.

FIG. 12 shows an image of the formation of carbon produced in Example 1.

FIG. 13 shows another image of the formation of carbon produced in Example 1.

### DETAILED DESCRIPTION

In order to address the issues with hydrogen production and the concurrent production of carbon dioxide, various forms of hydrocarbon reactions can be carried out to shift the carbonaceous product to solid carbon. This can be accomplished via several different reaction pathways including:

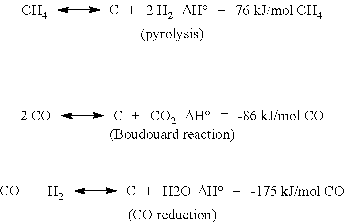

It should be understood that when C, H, and O are present, other reactions including water gas shift (WGS), reverse water gas shift (rWGS), methanation, and hydrocarbon reforming will be occurring to shift the composition towards thermodynamic equilibrium. The carbon forming reactions tend to be either strongly endothermic or strongly exothermic, requiring continuous heat addition or removal from the reactor. This can be problematic as solid surfaces have a propensity to accumulate carbon when carbon formation reactions are occurring. Additionally, the large heat of reaction can reduce the overall thermal efficiency of the process by requiring large heat flows between streams. It is advantageous to have the net reaction within the carbon formation reactor be autothermal or exothermic to eliminate the need for heat addition/removal and increase thermal efficiency. The coupling of carbon formation reactions and/or the coupling of carbon formation reactions with other complementary reactions (e.g. reforming, WGS) can be used to achieve this goal.

In shifting the carbonaceous product to solid carbon, CO₂ can be used as a feedstock to make the process CO₂-negative at the expense of reducing or eliminating H₂ output. This can be advantageous for processes that produce CO₂, but do not have a low-cost means of utilization or sequestration. Given that CO₂ is lower energy than C, this process requires significant energy input. Reacting CO₂ with other high energy species (e.g., CH₄) that make the net reaction autothermal or exothermic could allow for low-cost CO₂ sequestration as solid carbon.

As disclosed herein, a system that uses hydrocarbons (e.g., light alkanes such as CH₄, naphtha, biomass, ethanol, plant oils, crude oil, etc.), O₂, and CO₂ as feedstocks and produces predominantly C, H₂O, and H₂ can be designed to utilize a carbon formation reactor that operates autothermally, substantially autothermally, or exothermically. In some aspects, this process can be referred to as oxypyrolysis, and when methane is used as the feedstock, this process can be referred to as methane oxypyrolysis. As used herein, the term substantially autothermal or substantially authothermally refers to the net reaction occurring within a reactor having a heat of reaction between −50 kJ and 50 kJ per mol of carbon contained in the reactant species. This can be performed in single reactor or a series of reactors. When a series of reactors is used, the hydrocarbons and/or CO₂ can first be reacted to form predominantly CO as the carbonaceous species which is fed into the carbon formation reactor along with predominantly hydrocarbons (e.g., CH₄, naphtha, biomass, ethanol, plant oils, crude oil, etc), oxygen, carbon dioxide, and any recycle gases. This can be accomplished by one of several means including hydrocarbon reforming (steam reforming, dry reforming, autothermal reforming, biomass/coal gasification, or any combination thereof), reverse water gas shift (rWGS), or CO₂ electrolysis. If the CO production reactor is endothermic, an energy input source that is carbon free (e.g., H₂ combustion, electricity) is desired. Within the carbon formation reactor, the overall heat of reaction can be modulated to near zero (e.g., be autothermal) by performing other complementary reactions. This process may allow for chemical heating that can be efficient and avoid the complexities associated with high temperature heat transfer mechanisms (e.g., molten heat transfer and reaction media).

In some aspects, the hydrocarbons and/or CO₂ can first be reacted with O₂ or H₂O to form predominantly H₂, CO, and H₂O. This can be accomplished by one of several means including hydrocarbon reforming (steam reforming, dry reforming, autothermal reforming, biomass/coal gasification, or any combination thereof), reverse water gas shift (rWGS), or CO₂ electrolysis. The H₂O is separated and the rest of the gases are fed into the carbon formation reactor along with recycle gases. If the H₂ and CO production reactor is endothermic, an energy input source that is carbon free (e.g., H₂ combustion, electricity) is desired. Within the carbon formation reactor, the overall heat of reaction may be exothermic due to the predominance of the Boudouard and CO reduction reactions. It should be understood that the heat of reaction could be autothermal if significant methanation and reverse water gas shift reactions occur.

Within the process, a form of oxygen can be used to promote the formation of H₂O and add heat to the reaction. Oxygen can be present in the form of elemental oxygen (O₂) and/or carbon monoxide (CO). When CO is used, the CO can be converted directly to solid carbon, for example, using the Boudouard reaction or CO reduction reaction. The CO can be generated or regenerated using dry reforming of methane (DRM), water gas shift (WGS) reactions, and CO/CO₂ shift reactions as needed. In some embodiments, oxygen can be introduced as a species into the system and removed at one or more locations as an oxygen containing species such as water (e.g., as steam or liquid water) and/or carbon dioxide (CO₂). Water can be selected as the target species for the removal of oxygen in some aspects in order to avoid CO₂ emissions from the system.

In some aspects, the process can recycle hydrocarbons, CO, and CO₂, to prevent their emission. Recycling CO₂ is more thermodynamically expensive than hydrocarbons, H₂, or CO. The carbon formation reactor can be operated with high H₂ to CO ratios, and with some CO₂ in the feed to suppress the Boudouard reaction and promote CO reduction, thereby decreasing formation of more CO₂ that needs to be recycled. Alternatively, a reverse water gas shift reactor can be placed downstream of the carbon formation reactor to shift CO₂ and H₂ to CO and H₂O.

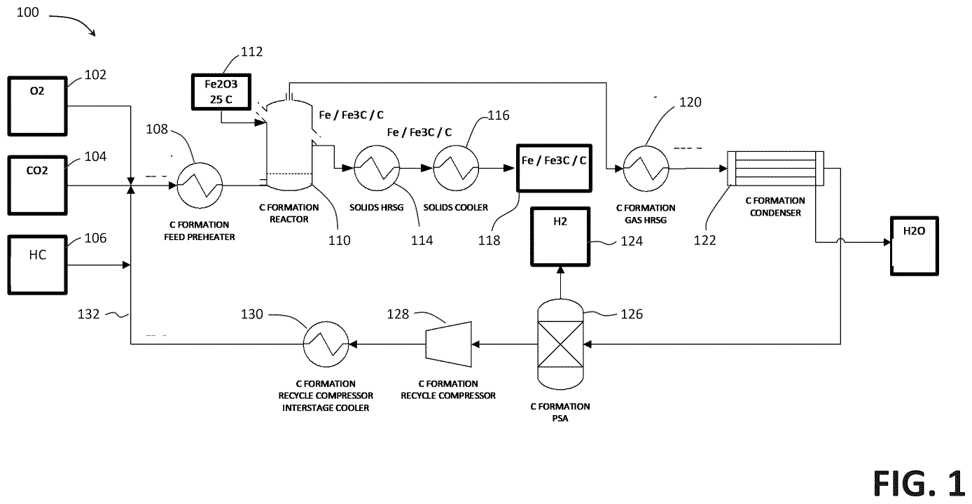

A system 100 for autothermal C, H₂, and H₂O formation from a feed containing a hydrocarbon, O₂, and CO₂ is shown in FIG. 1. As illustrated, the system 100 contains a single carbon formation reactor 110 fed by a stream 106 comprising a hydrocarbon, a stream 102 comprising oxygen, and a stream 104 comprising CO₂. The hydrocarbon can comprise any of those described herein including light alkanes such as methane, ethane, natural gas, as well as other gaseous, liquid, and solid hydrocarbons (e.g. ethanol, crude oil, biomass, naphtha, etc.). In some aspects, a gasification reactor can be used to convert one or more hydrocarbon containing species into a gaseous stream. In some aspects, the hydrocarbon can be provided as a fluidized solid or other form. Stream 102 can comprise an oxygen enriched stream in some aspects. An oxygen enriched stream refers to any stream having an oxygen concentration greater than the atmospheric concentration of oxygen. The oxygen stream 102 can be obtained at a desired purity from an oxygen storage tank, or via an oxygen enrichment process, for example, the separation of air into nitrogen and oxygen, such as pressure swing adsorption (PSA), vacuum swing adsorption (VSA), or cryogenic separation techniques. The oxygen in the oxygen stream 102 may have at least about 70 vol %, at least 80 vol %, or at least 90 vol % oxygen (e.g., 90, 91, 92, 93, 94, 95, 96, 97, 98, 99, 99.1, 99.2, 99.3, 99.4, 99.5, 99.6, 99.7, 99.8, 99.9, or 100 vol % oxygen). While shown as three separate streams in FIG. 1, the components can be provided in a single or otherwise combined stream. A recycle gas stream can also be combined with the inlet stream as described in more detail herein.

The feed stream(s) can be preheated in preheater 108 and introduced into the carbon formation reactor 110 along with a catalyst stream 112 comprising a catalyst. The individual feed streams may be at any suitable pressure and temperature, and one or more heat exchangers (e.g., preheater 108, etc.) can be used to adjust the temperature of the corresponding stream. The combined stream may have a pressure between about 1 bar to about 50 bar, or between about 5 bar and about 20 bar. The preheater 108 can be used to heat the incoming combined stream to a temperature between about 200° C. to about 700° C., or between about 250° C. to about 400° C., which can be the inlet temperature to the carbon formation reactor 110.

Within the carbon formation reactor 110, carbon forms along with H₂ and H₂O. Various reactions can occur that can result in the formation of solid carbon and other reaction products comprising hydrogen, water, CO, and CO₂ according to the following reactions:

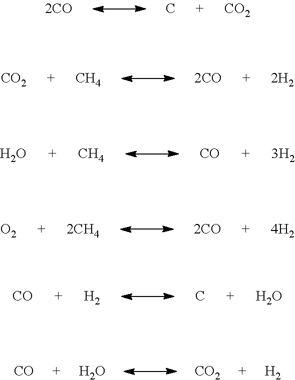

The reactions occurring are both exothermic and endothermic. The reaction conditions within the carbon formation reactor 110 may include a pressure of between about 1 bar to about 50 bar, or between about 1 bar to about 20 bar, a temperature of about 400° C. to about 1000° C., or between about 500° C. to about 750° C. The temperature within the reactor may be maintained by providing an adiabatic reactor vessel and/or providing the reactants at the desired temperature into the reactor to maintain the temperature within the desired temperature range. The carbon formation reactor 110 can take a variety of forms such as a fixed bed reactor, a fluidized bed reactor, a moving bed reactor, or the like.

The reactor can use a catalyst to promote the reactions and the formation of solid carbon. The catalyst material can include any material suitable for catalyzing the formation of the solid carbon material from the carbon oxide and the gaseous reducing material. As an example, the catalyst material may be an element of Group VI, Group VII, Group VIII, Group IX, or Group X of the Periodic Table of Elements (e.g., iron, nickel, molybdenum, platinum, chromium, cobalt, tungsten, etc.), an actinide, a lanthanide, oxides thereof, alloys thereof, or combinations thereof. Any metal known to be subject to metal coking may also be suitable for use as the catalyst material.

The catalyst material may be provided within the carbon formation reactor 110 (e.g., within the reaction chamber) as one or more solid structures (e.g., a particle, a wafer, cylinder, plate, sheet, sphere, pellet, mesh, fiber, etc.), and/or as at least a partial coating on another structure (e.g., particles of the at least one material deposited on a structure, such as a wafer, cylinder, plate, sheet, sphere, mesh, pellet, etc.) within the reactor vessel. In some embodiments, the catalyst material may be provided within the reactor as a plurality of particles or particulates. The catalyst material may be stationary (e.g., as a catalyst bed) or mobile (e.g., as a fluidized bed) within the reactor. In some embodiments, a portion of the catalyst material may be mobile within the reactor and another portion of the catalyst material may be stationary within the reactor.

As an example, the catalyst for the carbon formation reaction can include an iron-based catalyst. While not intending to be limited by theory, a dissociated carbon (e.g., a methane dissociated in contact with the iron, and/or one or more carbon oxides within the reactor) can contact the iron (e.g., a ferrite) within the catalyst to form an iron carbide. The iron carbide can then dissociate to reform the ferrite along with a layer of carbon (e.g., graphite, etc.) on the ferrite. The process can continue and result in the buildup of carbon layers on the ferrite, where the reaction rate can decrease as the thickness of the carbon layer on the iron builds due to increased diffusion resistance to the reactive iron core. The catalyst may then deactivate upon the buildup of a sufficient carbon layer.

The formation of the solid carbon then occurs on or around the catalyst such that the removal of solid carbon from the reactor vessel (e.g., using a separator such as a cyclone, settling chamber, etc.) can also result in the removal of the catalyst from the reactor. As a result, a small amount of catalyst may be introduced into the carbon formation reactor 110 along with the reactants while a corresponding amount of catalyst may be removed with the solid carbon. In some aspects, the amount of catalyst added into the reactor may have a mass ratio of catalyst to reactants of between about 0.0001:1 to about 1:1, or between about 0.001:1 to about 0.1:1.

As shown in FIG. 1, the catalyst stream 112 comprising the catalyst may be introduced into the carbon formation reactor 110. The catalyst may comprise an oxide, and the resulting oxygen in the oxide as well as the oxygen in the CO may form some amount of water in the gaseous product stream from the carbon formation reactor 110. The products from the carbon formation reactor can then include the gaseous product stream comprising CO, H₂O, H₂, and CO₂, while the solid product stream can comprise solid carbon along with the catalyst or a portion of the catalyst. The solid product stream can be removed from the carbon formation reactor 110 as a separate product stream from the gaseous product stream and removed from the system 100.

The carbon formation reactor 110 can form solid carbon that can be removed as a solids stream and a gaseous stream comprising CO, H₂O, H₂, and CO₂. The reaction can result in an outlet temperature in the range of 400-750° C., and the solids stream can pass to one or more heat exchangers 114, 116 to cool the solids product. The first heat exchanger 114 can serve as a heat recovery steam generator to produce steam for use within the system. A further trim cooler 116 can be used to produce a solids stream 118 that can leave the system for further handling. The solids stream can comprise predominantly carbon with some amount of the catalytic material included. In some aspects, the mass ratio of the solid carbon to the catalytic material can be in the range of about 500:1 to about 1:1, or in a range of about 50:1 to about 5:1.

The gaseous products leaving the carbon formation reactor 110 can pass to a heat exchanger 120 to cool the products. As with the solid products, the high temperature gaseous products can be cooled in an exchanger 120 that can serve as a heat recovery steam generator to generate steam. The cooled gas stream can then pass to a condenser 122. The condenser 122 can be used to remove any excess water from the stream as condensed steam. In the system 100 of FIG. 1, the addition of oxygen into the carbon formation reactor 110 can result in excess oxygen being present. The oxygen can leave the system as water in the condensed water stream so that the oxygen is removed as water rather than CO₂.

The remaining gas stream from the condenser 122 can predominantly comprise CO₂, H₂, and unreacted hydrocarbons, though some trace compounds may also be present. The hydrogen in the stream can be removed in a separator 126 to form hydrogen stream 124. As shown in FIG. 1, a separation unit 126 such as a pressure swing adsorption (PSA) unit can be used to separate at least a portion of the hydrogen from the product stream from condenser 122. While shown as a PSA unit, other suitable separation units such as temperature swing adsorption, membrane units, and the like can also be used to separate at least a portion of the hydrogen. In some aspects, at least about 50%, at least about 60%, at least about 70%, at least about 80%, or at least about 90% of the hydrogen (by volume) in the product stream from the condenser 122 can be separated in the separation unit 126 to form the hydrogen product stream 124 and a recycle stream having a reduced hydrogen concentration.

The remaining unreacted hydrocarbons and CO₂ in the recycle stream can be compressed in compressor 128 and cooled in heat exchanger 130 to form stream 132, which can be recycled to the inlet of the carbon formation reactor 110.

The overall system 100 can be used to convert a feed comprising hydrocarbon to produce solid carbon and hydrogen. A higher hydrogen output can be obtained by reducing or eliminating the amount of CO₂ provided to the carbon formation reactor 110, and more CO₂ can be consumed to form carbon by limiting or eliminating the amount of hydrogen production. The addition of oxygen to allow the reforming reaction to operate in an autothermal manner can result in the introduction of additional oxygen that can be removed as water and/or CO₂, though removal as water may help to prevent the generation of CO₂ from the system.

In some aspects, the system can also be used to convert CO₂ introduced into the system into solid carbon and water, thereby capturing CO₂ as solid carbon. The conversion of CO₂ to carbon can be improved by not removing all or a portion of the hydrogen using the separator 126, for example, by bypassing the separator 126.

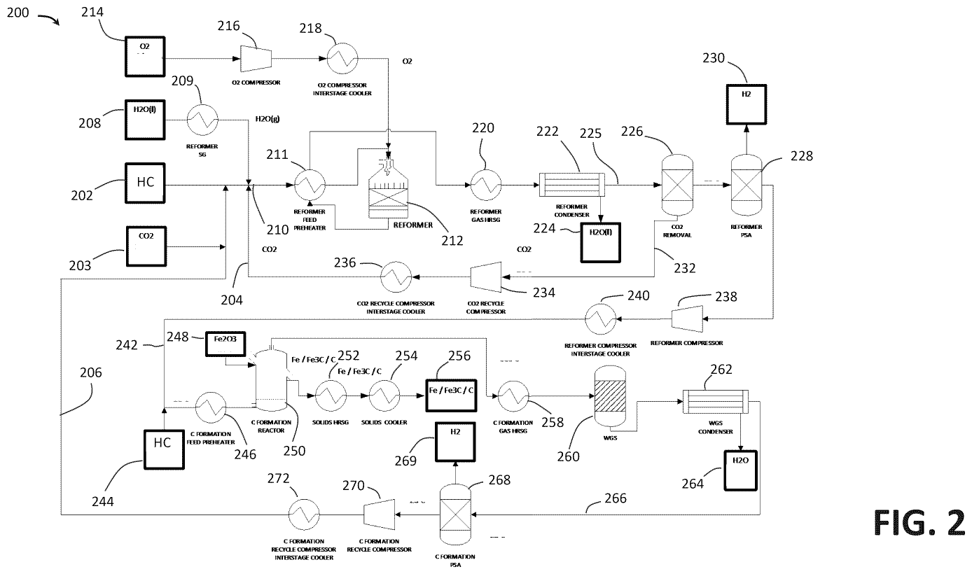

Another embodiment of a system 200 for the reaction of a hydrocarbon is illustrated in FIG. 2. The system 200 is similar in many respects to the system 100 described with respect to FIG. 1. Additional components are shown in the system 200, any one or more of which may also be present in the system 100 of FIG. 1. As shown in FIG. 2, a hydrocarbon stream 202 comprising one or more hydrocarbons, including any of those described herein, can be combined with a recycled stream 204 comprising CO₂ and/or an external CO₂ stream 203 containing CO₂, a recycle stream 206 comprising unreacted hydrocarbons, and an optional water stream 208 (e.g., provided as steam, etc.) to form a combined feed stream 210. The individual feed streams may be at any suitable pressure and temperature, and one or more heat exchangers (e.g., heat exchanger steam generator 209, etc.) can be used to adjust the temperature of the corresponding stream. The individual feed streams can be combined in any order and at any location, including by being introduced individually or in combination into the reformer 212. The combined feed stream 210 may have a pressure between about 1 bar to about 50 bar, or between about 5 bar and about 20 bar. A heat exchanger 211 can be used to heat the incoming combined stream 210 to a temperature between about 400° C. to about 700° C., or between about 500° C. to about 600° C., which can be the inlet temperature to the reformer 212.

In addition to the incoming combined feed stream 210, an oxygen stream 214 may be introduced into the system 200. One or more units such as a compressor 216 and heat exchanger 218 can be used to condition the oxygen stream 214 to be introduced into the reformer 212. The oxygen stream can comprise an oxygen enriched stream in some aspects. An oxygen enriched stream refers to any stream having an oxygen concentration greater than the atmospheric concentration of oxygen. The oxygen stream 214 can be obtained at a desired purity from an oxygen storage tank, or via an oxygen enrichment process, for example, the separation of air into nitrogen and oxygen, such as pressure swing adsorption (PSA), vacuum swing adsorption (VSA), or cryogenic separation techniques. The oxygen in the oxygen stream 214 may have at least about 70 vol %, at least 80 vol %, or at least 90 vol % oxygen (e.g., 90, 91, 92, 93, 94, 95, 96, 97, 98, 99, 99.1, 99.2, 99.3, 99.4, 99.5, 99.6, 99.7, 99.8, 99.9, or 100 vol % oxygen).

Within the reformer 212, both combustion and reforming reactions can occur, and the reformer 212 can operate in an autothermal manner with the proper ratio of hydrocarbon to oxygen. The exothermic combustion reaction can occur according to the following (using methane as an example):

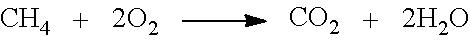

The resulting CO₂ and water, in addition to the CO₂ and water in the inlet stream 210, can then take place in one or more reforming reactions as described herein to produce CO and H₂. The use of the exothermic combustion reaction can supply the heat needed to drive the reforming reactions within the reformer 212, which can reduce the need for any external heating of the reforming reactor.

The reformer 212 can operate under any suitable conditions and catalysts to form CO and H₂. The use of the reformer 212 can allow for reforming of the hydrocarbons in the feedstock, including the gasification of heavy feedstocks such as biomass, crude oil, coal, and the like using oxygen (e.g., as provided in stream 214) or other oxygen carriers (e.g., H₂O, CO₂, etc.). In some instances, the operation of the reformer 212 may be endothermic to some degree, and heat can be provided directly or indirectly. When any portion of the heat is supplied other than through the introduction of O₂ into the reformer 212, the heat source may be generated using CO₂ free sources such as through the combustion of hydrogen and/or using electrical sources. In some aspects when electrical heating is used, the electricity can be generated using green sources such as wind or solar generation.

In some aspects, the reformer 212 can function using the dry reforming of methane (DRM). Dry reforming of a hydrocarbon occurs according to the reaction:

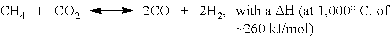

The DRM unit can carry out the reforming reaction in a reactor vessel, which can contain a catalyst to improve the reforming reaction rates. The reactor can take a variety of forms such as a fixed bed reactor, a fluidized bed reactor, a moving bed reactor, or the like. The hydrocarbon feed can comprise a hydrocarbon such as methane and carbon dioxide in equimolar amounts or nearly equimolar amounts. While described as comprising methane, other hydrocarbon containing streams can also be used including any of those described herein. When a DRM unit is used as the reformer 212, the feed to the reformer 212 may be free of water or substantially free of water.

When a DRM unit is used as the reformer 212, the reformer 212 may optionally comprise any suitable catalyst(s). Exemplary catalysts can include supported or bulk catalyst containing Group VIII (Columns 8-10), Group IX, or Group X metals that are catalytically active towards reforming reactions. By way of example, nickel, cobalt, rhodium, ruthenium, or platinum or any combination thereof based catalysts can be used in dry methane reforming.

When a DRM unit is used as the reformer 212, the reaction conditions within the reformer 212 may include a pressure of between about 1 bar to about 50 bar, or between about 1 bar to about 20 bar, a temperature of about 750° C. to about 1100° C., or between about 800° C. to about 950° C., and a GHSV of about 500 h⁻¹ to about 100,000 h⁻¹. In some embodiments, the hydrocarbon (e.g., methane, etc.) conversion in the reaction can be about 60% to about 80%. The hydrogen gas to carbon monoxide ratio (H₂/CO) in the product stream leaving the reformer 212 can range from about 0.5 to about 1. In some aspects, the hydrogen gas to carbon monoxide ratio (H₂/CO) in the product stream leaving the reformer 212 can be at least about 0.1, at least about 0.25, at least about 1, or at least about 1.5, and/or the hydrogen gas to carbon monoxide ratio (H₂/CO) in the product stream leaving the reformer 212 can be less than about 10, less than about 8, less than about 6, less than about 4, or less than about 2. In addition, some amount of unreacted hydrocarbon gas and carbon dioxide can also be present depending on the overall conversion.

In some aspects, the reformer 212 can function as a steam methane reformer (SMR). An SMR unit can carry out the reaction of water with a hydrocarbon feed to form CO and H₂. An exemplary SMR reaction using methane as an example can proceed according to the following:

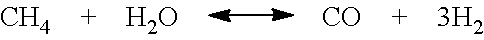

When CO₂ is introduced along with the hydrocarbon and water, some amount of dry reforming can also occur according to the following:

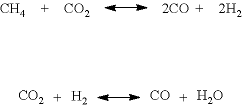

The SMR unit can carry out the reforming reaction in a reactor vessel, which can contain a catalyst to improve the reforming reaction rates. The hydrocarbon feed can comprise any of the hydrocarbon feeds as described herein such as methane. The feed to the SMR unit can also comprise steam. In some embodiments, the reformer can comprise any suitable reactor, such as for example a tubular reactor, a multitubular reactor, and the like, or combinations thereof.

In some embodiment, the SMR unit can comprise a nickel-based catalyst (e.g., sulfur sensitive nickel-based catalyst) and/or a sulfur passivated nickel-based catalyst (to avoid carbon depositions). The reforming reaction for hydrocarbons such as methane can be endothermic, and a reaction rate depends on the temperature, pressure and catalyst type. The endothermic nature of the reforming reaction can be balanced with the exothermic reaction based on the reaction of oxygen with the hydrocarbon such that the overall reaction is autothermal or substantially autothermal. The hydrocarbon can undergo the reforming reaction at high temperatures, however, in the presence of a catalyst (e.g., nickel-based catalyst), the temperature at which the hydrocarbon can be reformed can be lowered. The SMR reaction can be carried out at a temperature between about 700° C. to about 1100° C., or from about 800 C to about 900° C. In an embodiment, the reformer can be characterized by a reforming pressure of from about 1 bar to about 30 bars.

The outlet stream from the reformer 212 can be at the operating temperature of the reformer 212 of between about 700° C. to about 1100° C. The outlet stream can pass through the heat exchanger 211 to cool the outlet stream while heating the combined feed stream 210. The outlet stream leaving the exchanger can be cooled between about 200° C. to about 400° C. in the exchanger 211. The outlet stream can be further cooled in a second exchanger 220 to cool the outlet stream to condense at least a portion of any remaining water. The heat exchanger 220 can be any suitable exchanger, and in some embodiments may include a heat recovery steam generator for generating steam within the system. The stream can then be cooled to between 0° C. to 50° C., or to less than 30° C. in the condenser 222 to condense at least a portion of the water in the outlet stream. The condensed water can be removed as water stream 224. When higher levels of water removal are needed, additional or alternative units can be used such as glycol dehydrators and the like. The remaining stream 225 can then comprise CO, CO₂, H₂, unreacted hydrocarbons, and trace amounts of water.

The stream 225 can then pass to a CO₂ removal unit 226 for separating and recycling at least a portion of the CO₂ in the stream 225 to the inlet of the reformer. The CO₂ removal unit 226 can comprise any suitable units and processes for removing CO₂. Such units can include membrane units, cryogenic separation units, CO₂ absorption units, and the like. In some aspects, the CO₂ can be removed using a CO₂ absorption step. In this process, CO₂ is absorbed in a solvent to form a CO₂ loaded rich solvent. The so formed rich solvent can then be regenerated by flashed regeneration at various pressures. Such processes can remove almost all the CO₂ in the stream to leave the remaining product stream 225 with a very low CO₂ content (at typically less than 2 mol %, and more typically at less than 1 mol %). Suitable solvents, absorbers, and flash units are generally available. The removed CO₂ in stream 232 can be sent to a compressor 234 before passing to a heat exchanger 236 to form recycled stream 204 as part of the inlet stream to the reformer 212.

The remaining portions of stream 225 can pass to a separator 228. The separator 228 can include any of the separator units as described with respect to FIG. 1. While shown as a pressure swing adsorption unit, any suitable separation units for separating hydrogen from the stream 225 can be used. The separated hydrogen in stream 230 can leave the system 200. The remaining stream can be formed from CO, unreacted hydrocarbons, and trace amounts of components including water, CO₂, and hydrogen (along with some potential trace compounds). The stream can pass to the compressor 238 and heat exchanger 240 to be cooled and compressed before passing as stream 242 to heat exchanger 246. An additional amount of hydrocarbon in stream 244 can be combined with the stream 242 to provide the desired ratio of CO to the hydrocarbon fed to the carbon formation reactor 250. The heat exchanger 246 can serve as a feed preheater to heat the combined feed stream fed to the carbon formation reactor 250. The carbon formation reactor 250 can be the same as carbon formation reactor 110 described with respect to FIG. 1. A catalyst in stream 248 can be passed to the carbon formation reactor 250 for use in forming solid carbon. The catalyst can include any of the catalyst(s) described with respect to stream 112 in FIG. 1.

The carbon formation reactor 250 can carry out any of the reactions described with respect to FIG. 1 to form solid carbon that can be removed as a solids stream and a gaseous stream comprising CO, H₂O, H₂, and CO₂. The reaction can result in an outlet temperature in the range of 400-700° C., and the solids stream can pass to one or more heat exchangers 252, 254 to cool the solids product 256. The first heat exchanger 252 can serve as a heat recovery steam generator to produce steam for use within the system. A further trim cooler 254 can be used to produce a solids stream that can leave the system for further handling.

The gaseous products can pass to a heat exchanger 258 to cool the products. As with the solid products, the high temperature gaseous products can be cooled in an exchanger 258 that can serve as a heat recovery steam generator to generate steam. The cooled gaseous products can then pass to an optional WGS unit 260. The WGS unit can serve to shift the CO and water to form CO₂ and hydrogen within the gaseous stream. Within the WGS unit 260, CO and water are reacted to form CO₂ and H₂ according to the WGS reaction as follows:

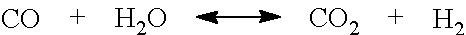

The WGS reaction is exothermic and is affected by temperature, with higher conversion of CO at lower temperatures. An inlet heat exchanger (e.g., heat exchanger 258) can be used to obtain the desired temperature of the gaseous product stream from the carbon formation reactor 250. The WGS unit 260 can take a variety of forms including the use of one or more fixed bed reactors. When a plurality of reactors is used, one or more inter-stage heat exchangers (e.g., coolers, etc.) can be used to maintain a desired temperature within the reactors. The reaction conditions within the WGS unit 260 may include a pressure of between about 1 bar to about 50 bar, or between about 1 bar to about 20 bar, a temperature of about 150° C. to about 500° C., or between about 200° C. to about 400° C.

The WGS reaction can take place in the presence of a WGS catalyst. The WGS shift catalyst may be provided and supported in any form suitable for carrying out the WGS reaction. For example, the shift catalyst may be provided as a fixed bed that is positioned in the shift reactor such that gases are able to flow through the catalyst bed. Examples of suitable WGS catalysts can include, but are not limited to, cobalt-molybdenum (Co—Mo), nickel-molybdenum (Ni—Mo) catalysts, chromium or copper promoted iron-based catalysts, zinc oxide-promoted copper catalysts, or any combination thereof.

The product stream from the WGS unit 260 can have a reduced CO and water content relative to the gaseous product stream from the carbon formation reactor 250. The products stream may then predominantly comprise CO₂ and H₂ with minor or trace amounts of CO, water, and potentially unreacted hydrocarbons from the carbon formation reactor 250.

In some aspects, the system 200 may not have the WGS unit 260. In these aspects, the gaseous products leaving the exchanger 258 can pass directly to the condenser 262. The stream 266 can then also include a greater amount of CO relative to a system comprising the WGS unit 260. The CO can then pass in the recycle stream 206 back to the inlet of the reformer 212.

A condenser 262 can be used to remove any excess water from the stream after the WGS unit 260 as condensed stream 264. In the system 200 of FIG. 2, the addition of oxygen into the reformer 212 can result in excess oxygen being present. The oxygen can leave the system as water in either stream 224 and/or 264 so that the oxygen is removed as water rather than CO₂.

The remaining gas stream 266 can predominantly comprise CO₂, H₂, and unreacted hydrocarbons, though some trace compounds may also be present. The hydrogen in the stream can be removed in a separator 268 to form hydrogen stream 269. The separator 268 can include any of the separator units as described with respect to FIG. 1. While shown as a pressure swing adsorption unit, any suitable separation units for separating hydrogen from the stream 266 can be used. The remaining unreacted hydrocarbons and CO₂ can be compressed in compressor 270 and cooled in heat exchanger 272 to form stream 206, which can be recycled to the inlet of the reformer 212.

The overall system 200 can be used to perform the reaction of the hydrocarbons to produce solid carbon and hydrogen. The addition of oxygen to allow the reforming reaction to operate in an autothermal manner can result in the introduction of additional oxygen that can be removed as water and/or CO₂, though removal as water may help to prevent the generation of CO₂ from the system.

In some aspects, the system can also be used to convert CO₂ introduced into the system into solid carbon and water, thereby capturing CO₂ as solid carbon.

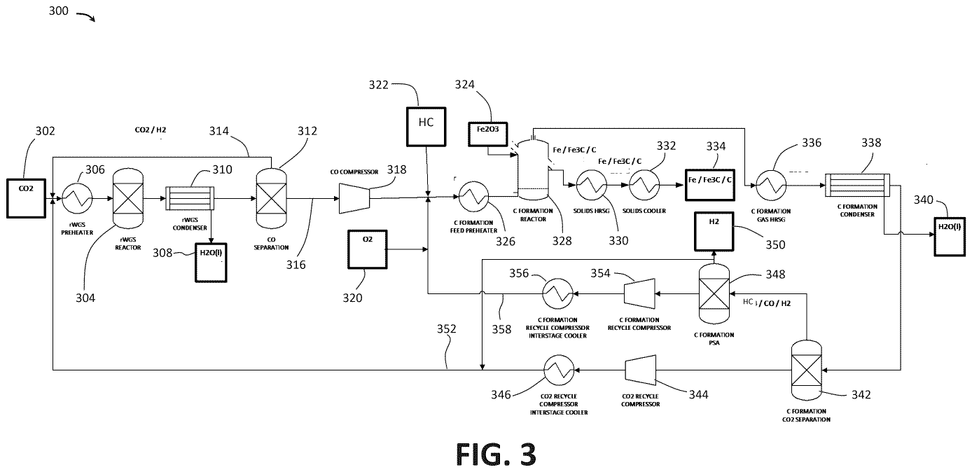

Another system 300 for producing solid carbon and hydrogen is shown in FIG. 3 using a reverse water gas shift (rWGS) reactor 304 to convert CO₂ to CO using H₂. As shown an inlet stream 302 comprising CO₂ can be provided to the system and combined with a recycle stream 314 comprising CO₂ and H₂ as well as a second recycle stream 352 that comprises CO₂ and optionally some amount of H₂. The combined stream comprising predominantly CO₂ and H₂ can be heated in an exchanger 306 before passing to the rWGS reactor 304. The exchanger 306 can comprise any of the exchangers disclosed herein, and can heat the combined feed stream to a temperature of between about 200° C. to about 700° C., depending on the nature of the rWGS reactor 304.

The rWGS reactor can convert CO₂ to CO using H₂ according to the following equation:

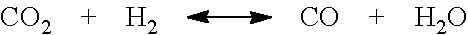

The rWGS reaction can be operated in the presence of one or more catalysts. Suitable catalyst can include those selected from the group consisting of ZnO, MnOx, alkaline earth metal oxides composite (or mixed metal) oxides. Further rWGS catalysts are known in the art.

The rWGS reaction can be carried out in one or more suitable reactors such as an adiabatic or heated reactor. Reactor vessels such as fixed bed reactors, fluidized bed reactors, or the like can be used. For example, the rWGS reactor can comprise a fixed bed catalyst disposed in one or more tubular reactors configured in an adiabatic reactor or in a heat reactor with the tubular reactors being externally heated. The rWGS reactor can be operated at a temperature in a range of from about 500° C. to about 800° C., and any suitable pressure used within the system such as between about 1 bar to about 50 bar, or between about 5 bar and about 20 bar. The conversion efficiency of CO₂ to CO can be above 30%.

The stream leaving the reverse water gas shift (rWGS) reactor 304 can pass to a condenser 310 to remove at least a portion of the water produced in the rWGS reactor 304. The condenser 310 can be the same or similar to the condensers described with respect to FIGS. 1 and 2. The resulting water stream 308 can then leave the system. The remaining stream can then pass to a CO separation system 312 to separate the CO from the CO₂ and H₂ in the stream. Various CO separation systems can be used including solvent based system to selectively separate CO from the remaining components including CO₂ and H₂. One exemplary solvent based process uses the complexation/decomplexation of carbon monoxide in a solvent containing cuprous aluminum chloride (CuAlCl₄) dissolved in an organic liquid such as toluene, which is known by the trade name COPureSM from R.C. Costello & Assoc. Inc. of Redondo Beach, California. While described as removing CO, other suitable separation processes can also be used with the CO separation system 312 including the sequential separation of H₂ and CO₂ (in either order) from the stream using adsorption and/or solvent based systems. The remaining CO can then be used in the remainder of the process.

The resulting CO₂ and H₂ separated from the outlet of the condenser 310 can be recycled as stream 314 to the inlet of the rWGS reactor 304 for further conversion. Stream 316 can comprise a majority of CO with some minor amounts of other components including CO₂, H₂, and water. Stream 316 can pass to compressor 318. Additional components can be combined with stream 316 before and/or after passing to the carbon formation feed preheater 326. In some aspects, a recycle stream 358 comprising unreacted hydrocarbons and CO can be combined with the CO stream 316. Additional hydrocarbon can be added from stream 322, and oxygen can be added in stream 320. The hydrocarbon in stream 322 can comprise any of the hydrocarbons described herein, and the oxygen can be provided as an oxygen enhanced stream. The amount of each component can be controlled to provide the desired ratio of hydrocarbon, oxygen, and CO in the feed to the carbon formation reactor 328. In some aspects, oxygen may be added when increasing or maximizing hydrogen production from the system 300 is desired, and oxygen addition may be reduced or eliminated if converting CO₂ into solid carbon is desired.

The carbon formation feed preheater 326 can be any suitable exchanger as described herein. The feed to the carbon formation reactor 328 can be heated to a temperature between about 200° C. to about 700° C. before passing to the carbon formation reactor 328. The carbon formation reactor 328 can be the same as carbon formation reactor 110 or the carbon formation reactor 250 described with respect to FIGS. 1 and 2. A catalyst in stream 324 can be passed to the carbon formation reactor 328 for use in forming solid carbon. The catalyst can include any of the catalyst(s) described with respect to stream 112 or stream 248 in FIGS. 1 and 2.

The carbon formation reactor 328 can carry out any of the reactions described with respect to FIG. 1 to form solid carbon that can be removed as a solids stream and a gaseous stream comprising CO, H₂O, H₂, and CO₂. The reaction can result in an outlet temperature in the range of 400-700° C., and the solids stream can pass to one or more heat exchangers 330, 332 to cool the solids product. The first heat exchanger 330 can serve as a heat recovery steam generator to produce steam for use within the system. A further trim cooler 332 can be used to produce a solids stream 334 that can leave the system for further handling.

The gaseous products can pass to a heat exchanger 336 to cool the products. As with the solid products, the high temperature gaseous products can be cooled in an exchanger 336 that can serve as a heat recovery steam generator to generate steam. The cooled gaseous stream can then pass to a condenser 262, which can be used to remove any excess water from the stream after the heat exchanger 336. In the system 300 of FIG. 3, the addition of oxygen into the feed to the carbon formation reactor can result in excess oxygen being present. The oxygen can leave the system as water in either stream 308 and/or 340 so that the oxygen is removed as water rather than CO₂.

The remaining gas stream can predominantly comprise CO, CO₂, H₂, and unreacted hydrocarbons, though some trace compounds may also be present. The stream can pass to a CO₂ separation unit 342 to remove the CO₂ from the stream. The CO₂ separation unit 342 can be the same or similar to the CO₂ removal unit 226 as described with respect to FIG. 2, and can comprise any suitable units and processes for removing CO₂. The removed CO₂ in stream can be sent to a compressor 344 before passing to a heat exchanger 346 to form a CO₂ stream that can be combined with hydrogen to form the recycle stream 352, which can be sent to the inlet of the rWGS reactor 304.

The remaining components of the stream from the condenser 338 can be passed to a hydrogen separation unit 348, where at least a portion of the hydrogen can be separated from the unreacted hydrocarbon and CO. The hydrogen separation unit 348 can be the same or similar to the separator 126 described with respect to FIG. 1. At least a portion of the separated hydrogen can leave the system as hydrogen stream 350. A portion of the separated hydrogen can optionally be combined with the CO₂ stream from the CO₂ separation unit 342 to form a recycle stream comprising a blend of CO₂ and H₂. The remaining components including predominantly unreacted hydrocarbon and CO can be compressed in compressor 354 and cooled in exchanger 356 before being passed back to be part of the feed to the carbon formation reactor 328.

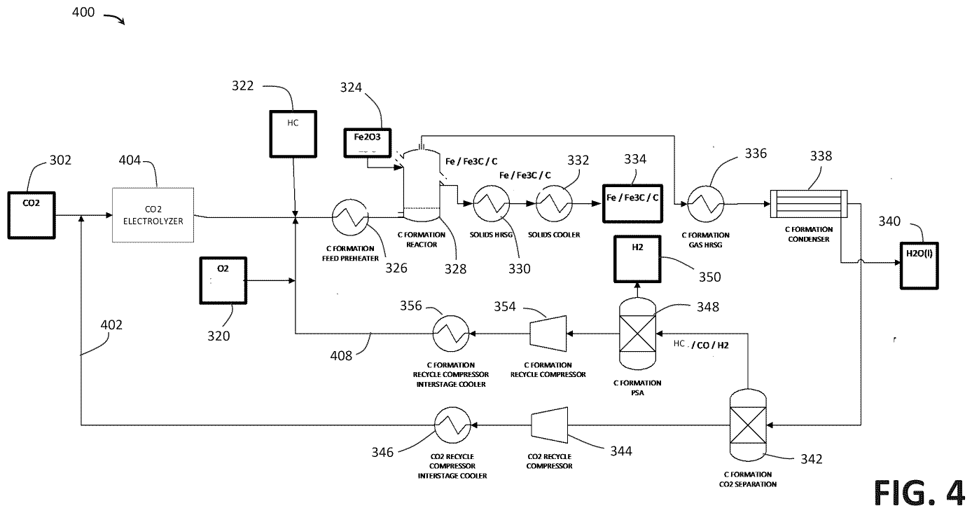

An additional system 400 for producing carbon is shown in FIG. 4. The system 400 is similar to the system 300 of FIG. 3 except that the reformer to produce CO from CO₂ and H₂ is replaced with an electrolyzer 404. The remaining elements of the system 400 can be the same or similar to those described with respect to FIG. 3, and similar components will not be described in detail in the interest of brevity.

As shown in FIG. 4, the CO₂ feed in stream 302 can be combined with a recycle stream 402 comprising CO₂. The electrolyzer can convert CO₂ to CO and O₂ using electrolysis process. The electricity for the electrolyzer 404 can be provided by any suitable source, and in some aspects, the electricity can be provided by sources such as solar or wind power. The outlet stream from the electrolyzer 404 can comprise CO, O₂, and some amount of unreacted CO₂. Depending on the amount of CO₂ present in the outlet stream from the electrolyzer 404, an optional CO₂ separation unit may be used. When the amount of CO₂ is low, no additional separation units are needed prior to passing the CO and O₂ to the carbon formation reactor 328. The electrolyzer 404 may also operate with a low pressure drop so that no additional compression or cooling is needed prior to passing to the carbon formation reactor 328.

Additional components can be combined with the electrolyzer output stream before and/or after passing to the carbon formation feed preheater 326. In some aspects, a recycle stream 408 comprising unreacted hydrocarbons and CO can be combined with the electrolyzer output stream. Additional hydrocarbon can be added from stream 322, and oxygen can be added in stream 320. The hydrocarbon in stream 322 can comprise any of the hydrocarbons described herein, and the oxygen can be provided as an oxygen enhanced stream. The amount of each component can be controlled to provide the desired ratio of hydrocarbon, oxygen, and CO in the feed to the carbon formation reactor 328. In some aspects, oxygen may be added when increasing or maximizing hydrogen production from the system 300 is desired, and oxygen addition may be reduced or eliminated if converting CO₂ into solid carbon is desired.

The carbon formation feed preheater 326 can be any suitable exchanger as described herein. The feed to the carbon formation reactor 328 can be heated to a temperature between about 200° C. to about 700° C. before passing to the carbon formation reactor 328. The carbon formation reactor 328 can be the same as carbon formation reactor 110 or the carbon formation reactor 250 described with respect to FIGS. 1 and 2. A catalyst in stream 324 can be passed to the carbon formation reactor 328 for use in forming solid carbon. The catalyst can include any of the catalyst(s) described with respect to stream 112 or stream 248 in FIGS. 1 and 2.

The carbon formation reactor 328 can carry out any of the reactions described with respect to FIG. 1 to form solid carbon that can be removed as a solids stream and a gaseous stream comprising CO, H₂O, H₂, and CO₂. The reaction can result in an outlet temperature in the range of 400-700° C., and the solids stream can pass to one or more heat exchangers 330, 332 to cool the solids product. The first heat exchanger 330 can serve as a heat recovery steam generator to produce steam for use within the system. A further trim cooler 332 can be used to produce a solids stream 334 that can leave the system for further handling.

The gaseous products can pass to a heat exchanger 336 to cool the products. As with the solid products, the high temperature gaseous products can be cooled in an exchanger 336 that can serve as a heat recovery steam generator to generate steam. The cooled gaseous stream can then pass to a condenser 338, which can be used to remove any excess water from the stream after the heat exchanger 336. The addition of oxygen into the feed to the carbon formation reactor can result in excess oxygen being present. The oxygen can leave the system as water in stream 340 so that the oxygen is removed as water rather than CO₂.

The remaining gas stream can predominantly comprise CO, CO₂, H₂, and unreacted hydrocarbons, though some trace compounds may also be present. The stream can pass to a CO₂ separation unit 342 to remove the CO₂ from the stream. The CO₂ separation unit 342 can be the same or similar to the CO₂ removal unit 226 as described with respect to FIG. 2, and can comprise any suitable units and processes for removing CO₂. The removed CO₂ in stream can be sent to a compressor 344 before passing to a heat exchanger 346 to form a CO₂ stream that can form the recycle stream 402, which can be sent to the inlet of the electrolyzer 404.

The remaining components of the stream from the condenser 338 can be passed to a hydrogen separation unit 348, where the hydrogen can be separated from the unreacted hydrocarbon and CO. The hydrogen separation unit 348 can be the same or similar to the separator 126 described with respect to FIG. 1. The separated hydrogen can leave the system as hydrogen stream 350. The remaining components including predominantly unreacted hydrocarbon and CO can be compressed in compressor 354 and cooled in exchanger 356 before being passed back to be part of the feed to the carbon formation reactor 328.

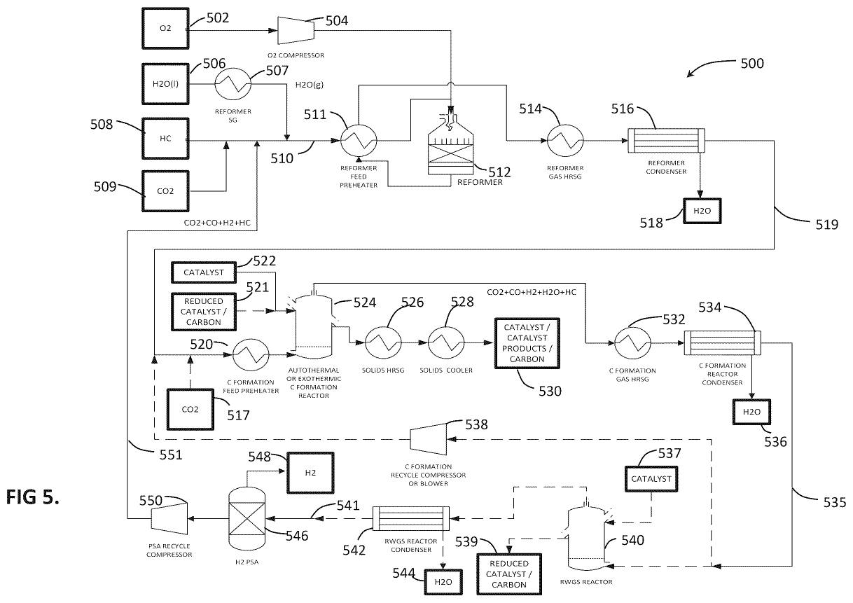

Another system is illustrated in FIG. 5, which illustrates a system 500 for autothermal or exothermic C, H₂, and H₂O formation from a feed containing a hydrocarbon, O₂ (e.g., in oxygen containing stream 502), H₂O, and CO₂. A hydrocarbon stream 508 comprising one or more hydrocarbons, can be combined with a recycled stream 551 comprising CO₂, CO, H₂, and hydrocarbon(s), an external CO₂ stream 509, and an optional water stream 506 (e.g., provided as steam, etc.) to form a combined feed stream 510. The hydrocarbon in the hydrocarbon stream 508 can comprise any of those described herein including light alkanes such as methane, ethane, natural gas, as well as other gaseous, liquid, and solid hydrocarbons (e.g. ethanol, crude oil, biomass, naphtha, etc.). In some aspects, a gasification reactor can be used to convert one or more hydrocarbon containing species into a gaseous stream. In some aspects, the hydrocarbon can be provided as a fluidized solid or other form. The individual feed streams may be at any suitable pressure and temperature, and one or more heat exchangers (e.g., heat exchanger steam generator 507, etc.) can be used to adjust the temperature of the corresponding stream. The individual feed streams can be combined in any order and at any location, including by being introduced individually or in combination into the reformer 512. The combined stream 510 may have a pressure between about 1 bar to about 50 bar, or between about 5 bar and about 20 bar. A heat exchanger 511 can be used to heat the incoming combined stream to a temperature between about 400° C. to about 800° C., or between about 500° C. to about 600° C., which can be the inlet temperature to the reformer 512.

In addition to the incoming combined stream at 510, an oxygen stream 502 may be introduced into the system 500. One or more units such as a compressor 504 can be used to condition the oxygen stream 502 to be introduced into the reformer 512. The oxygen stream can comprise an oxygen enriched stream in some aspects. An oxygen enriched stream refers to any stream having an oxygen concentration greater than the atmospheric concentration of oxygen. The oxygen stream 502 can be obtained at a desired purity from an oxygen storage tank, or via an oxygen enrichment process, for example, the separation of air into nitrogen and oxygen, such as pressure swing adsorption (PSA), vacuum swing adsorption (VSA), or cryogenic separation techniques. The oxygen in the oxygen stream 502 may have at least about 70 vol %, at least 80 vol %, or at least 90 vol % oxygen (e.g., 90, 91, 92, 93, 94, 95, 96, 97, 98, 99, 99.1, 99.2, 99.3, 99.4, 99.5, 99.6, 99.7, 99.8, 99.9, or 100 vol % oxygen).

Within the reformer 512, both combustion and reforming reactions can occur, and the reformer 512 can operate in an autothermal manner with the proper ratio of hydrocarbon to oxygen. The exothermic combustion reaction can occur according to the following (using methane as an example):

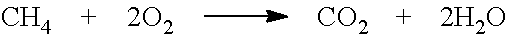

The resulting CO₂ and water, in addition to the CO₂ and water in the combined feed stream 510, can then take place in one or more reforming reactions as described herein to produce CO and H₂. The use of the exothermic combustion reaction can supply the heat needed to drive the reforming reactions within the reformer 512, which can reduce the need for any external heating of the reforming reactor.

The reformer 512 can operate under any suitable conditions and catalysts to form CO and H₂. The use of the reformer 512 can allow for reforming of the hydrocarbons in the feedstock, including the gasification of heavy feedstocks such as biomass, crude oil, coal, and the like using oxygen (e.g., as provided in stream 502) or other oxygen carriers (e.g., H₂O, CO₂, etc.). In some instances, the operation of the reformer 512 may be endothermic to some degree, and heat can be provided directly or indirectly. When any portion of the heat is supplied other than through the introduction of O₂ into the reformer 512, the heat source may be generated using CO₂ free sources such as through the combustion of hydrogen and/or using electrical sources. In some aspects when electrical heating is used, the electricity can be generated using green sources such as wind or solar generation. In some embodiments, the heat may also be supplied from carbon formation reactor 524 when it is operated in an exothermic manner.

In some aspects, the reformer 512 can function using the dry reforming of methane (DRM). Dry reforming of a hydrocarbon occurs according to the reaction:

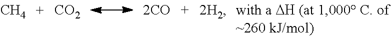

The DRM unit can carry out the reforming reaction in a reactor vessel, which can contain a catalyst to improve the reforming reaction rates. The reactor can take a variety of forms such as a fixed bed reactor, a fluidized bed reactor, a moving bed reactor, or the like. The hydrocarbon feed can comprise a hydrocarbon such as methane and carbon dioxide in equimolar amounts or nearly equimolar amounts. While described as comprising methane, other hydrocarbon containing streams can also be used including any of those described herein. When a DRM unit is used as the reformer 512, the feed to the reformer 512 may be free of water or substantially free of water.

When a DRM unit is used as the reformer 512, the reformer 512 may optionally comprise any suitable catalyst(s). Exemplary catalysts can include supported or bulk catalyst containing Group VIII (Columns 8-10), Group IX, or Group X metals that are catalytically active towards reforming reactions. By way of example, nickel, cobalt, rhodium, ruthenium, or platinum or any combination thereof based catalysts can be used in dry methane reforming.

When a DRM unit is used as the reformer 512, the reaction conditions within the reformer 512 may include a pressure of between about 1 bar to about 50 bar, or between about 1 bar to about 20 bar, a temperature of about 600° C. to about 1100° C., or between about 800° C. to about 950° C., and a GHSV of about 500 h⁻¹ to about 100,000 h⁻¹. In some embodiments, the hydrocarbon (e.g., methane, etc.) conversion in the reaction can be about 40% to about 80%. The hydrogen gas to carbon monoxide ratio (H₂/CO) in the product stream leaving the reformer 512 can range from about 0.5 to about 1. In some aspects, the hydrogen gas to carbon monoxide ratio (H₂/CO) in the product stream leaving the reformer 512 can be at least about 0.1, at least about 0.25, at least about 1, or at least about 1.5, and/or the hydrogen gas to carbon monoxide ratio (H₂/CO) in the product stream leaving the reformer 512 can be less than about 10, less than about 8, less than about 6, less than about 4, or less than about 2. In addition, some amount of unreacted hydrocarbon gas and carbon dioxide can also be present depending on the overall conversion.

In some aspects, the reformer 512 can function using steam methane reforming (SMR). An SMR unit can carry out the reaction of water with a hydrocarbon feed to form CO and H₂. An exemplary SMR reaction using methane as an example can proceed according to the following:

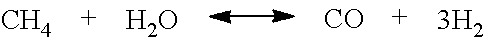

When CO₂ is introduced along with the hydrocarbon and water, some amount of dry reforming can also occur according to the following:

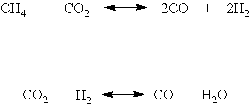

The SMR unit can carry out the reforming reaction in a reactor vessel, which can contain a catalyst to improve the reforming reaction rates. The hydrocarbon feed can comprise any of the hydrocarbon feeds as described herein such as methane. The feed to the SMR unit can also comprise steam. In some embodiments, the reformer can comprise any suitable reactor, such as for example a tubular reactor, a multitubular reactor, and the like, or combinations thereof.

In some embodiment, the SMR unit can comprise a nickel-based catalyst (e.g., sulfur sensitive nickel-based catalyst) and/or a sulfur passivated nickel-based catalyst (to avoid carbon depositions). The reforming reaction for hydrocarbons such as methane can be endothermic, and a reaction rate depends on the temperature, pressure and catalyst type. The endothermic nature of the reforming reaction can be balanced with the exothermic reaction based on the reaction of oxygen with the hydrocarbon such that the overall reaction is autothermal, nearly autothermal, or in some aspects, exothermic. The hydrocarbon can undergo the reforming reaction at high temperatures, however, in the presence of a catalyst (e.g., nickel-based catalyst), the temperature at which the hydrocarbon can be reformed can be lowered. The SMR reaction can be carried out at a temperature between about 700° C. to about 1100° C., or from about 800° C. to about 900° C. In an embodiment, the reformer can be characterized by a reforming pressure of from about 1 bar to about 30 bars.

The outlet stream from the reformer 512 can be at the operating temperature of the reformer 512 of between about 700° C. to about 1100° C. The outlet stream can pass through the exchanger 511 to cool the outlet stream while heating the combined inlet stream 510. The outlet stream leaving the exchanger can be cooled between about 200° C. to about 400° C. in the exchanger 511. The outlet stream can be further cooled in a second exchanger 514 to cool the outlet stream to condense at least a portion of any remaining water. The heat exchanger 514 can be any suitable exchanger, and in some embodiments may include a heat recovery steam generator for generating steam within the system. The stream can then be cooled to between 0° C. to 50° C., or to less than 30° C. in the condenser 516 to condense at least a portion of the water in the outlet stream. The condensed water can be removed as water stream 518. When higher levels of water removal are needed, additional or alternative units can be used such as glycol dehydrators and the like. The remaining stream 519 can then comprise CO, CO₂, H₂, hydrocarbons, and trace amounts of water.

The stream 519 can then pass to and be preheated in preheater 520 and be introduced into the carbon formation reactor 524 along with a catalyst stream 522 comprising a catalyst. In some aspects, an optional stream of CO₂ 517 can be introduced and mixed with stream 519 to adjust the amount of CO₂ and/or a ratio of CO₂ to the other components in stream 519 prior to passing to the carbon formation reactor 524. In some aspects, a reduced catalyst stream 521 can be introduced and optionally combined with the catalyst stream 522 prior to passing the catalyst into the carbon formation reactor 524. The individual feed streams may be at any suitable pressure and temperature, and one or more heat exchangers (e.g., preheater 520, etc.) can be used to adjust the temperature of the corresponding stream. The combined stream may have a pressure between about 1 bar to about 50 bar, or between about 5 bar and about 20 bar. The preheater 520 can be used to heat the incoming combined stream 519 to a temperature between about 200° C. to about 700° C., or between about 250° C. to about 400° C., which can be the inlet temperature to the carbon formation reactor 524.

Within the carbon formation reactor 510, solid carbon forms along with H₂O. Various reactions can occur that can result in the formation of solid carbon and other reaction products comprising hydrogen, water, CO, and CO₂ according to the following reactions:

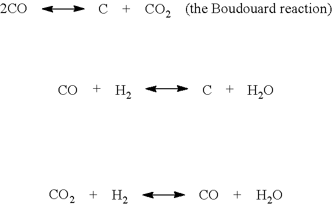

The reactions occurring are both exothermic and endothermic. The reaction conditions within the carbon formation reactor 524 may include a pressure of between about 1 bar to about 50 bar, or between about 1 bar to about 20 bar, a temperature of about 400° C. to about 1000° C., or between about 500° C. to about 750° C. The temperature within the reactor may be maintained by providing an adiabatic reactor vessel and/or providing the reactants at the desired temperature into the reactor to maintain the temperature within the desired temperature range, if autothermal or substantially autothermal. Cooling systems (e.g. H₂O cooling, reactor feed preheating, etc.) may be used if the reactor is operated exothermically. The carbon formation reactor 524 can take a variety of forms such as a fixed bed reactor, a fluidized bed reactor, a moving bed reactor, or the like.

The reactor can use a catalyst to promote the reactions and the formation of solid carbon. The catalyst material can include any material suitable for catalyzing the formation of the solid carbon material from the carbon oxide and the gaseous reducing material. As an example, the catalyst material may be an element of Group VI, Group VII, Group VIII, Group IX, or Group X of the Periodic Table of Elements (e.g., iron, nickel, molybdenum, platinum, chromium, cobalt, tungsten, etc.), an actinide, a lanthanide, oxides thereof, alloys thereof, or combinations thereof. Any metal known to be subject to metal coking may also be suitable for use as the catalyst material. The catalyst may also comprise carbon, and in some aspects, the catalyst may comprise substantially pure carbon. For example, solid carbon, carbon on another particulate material (e.g., sand, catalyst, etc.), or other forms of carbon can be used. This may allow the solid carbon formed in the reactor to be used as the growth media for the formation of the solid carbon, thereby producing carbon particulates.

The catalyst material may be provided within the carbon formation reactor 524 (e.g., within the reaction chamber) as one or more solid structures (e.g., a particle, a wafer, cylinder, plate, sheet, sphere, pellet, mesh, fiber, particulate, etc.), and/or as at least a partial coating on another structure (e.g., particles of the at least one material deposited on a structure, such as a wafer, cylinder, plate, sheet, sphere, mesh, pellet, etc.) within the reactor vessel. In some embodiments, the catalyst material may be provided within the reactor as a plurality of particles or particulates. The catalyst material may be stationary (e.g., as a catalyst bed) or mobile (e.g., as a fluidized bed) within the reactor. In some embodiments, a portion of the catalyst material may be mobile within the reactor and another portion of the catalyst material may be stationary within the reactor.

As an example, the catalyst for the carbon formation reaction can include an iron-based catalyst. While not intending to be limited by theory, a dissociated carbon (e.g., carbon monoxide dissociated in contact with the iron, and/or hydrogen or carbon dioxide within the reactor) can contact the iron (e.g., a ferrite) within the catalyst to form an iron carbide. The iron carbide can then dissociate to reform the ferrite along with a layer of carbon (e.g., graphite, etc.) on the ferrite. The process can continue and result in the buildup of carbon layers on the ferrite, where the reaction rate can decrease as the thickness of the carbon layer on the iron builds due to increased diffusion resistance to the reactive iron core. The catalyst may then deactivate upon the buildup of a sufficient carbon layer.

The formation of the solid carbon then occurs on or around the catalyst such that the removal of solid carbon from the reactor vessel (e.g., using a separator such as a cyclone, settling chamber, etc.) can also result in the removal of the catalyst from the reactor. As a result, a small amount of catalyst may be introduced into the carbon formation reactor 524 along with the reactants while a corresponding amount of catalyst may be removed with the solid carbon. In some aspects, the amount of catalyst added into the reactor may have a mass ratio of catalyst to reactants of between about 0.0001:1 to about 1:1, or between about 0.001:1 to about 0.1:1.

As shown in FIG. 5, the stream 519 may be introduced into the carbon formation reactor 524. The catalyst may comprise an oxide, and the resulting oxygen in the oxide as well as the oxygen in the CO may form some amount of water in the gaseous product stream from the carbon formation reactor 524. The products from the carbon formation reactor can then include the gaseous product stream comprising CO, H₂O, H₂, CO₂, and hydrocarbons, while the solid product stream can comprise solid carbon along with the catalyst or a portion of the catalyst. The solid product stream can be removed from the carbon formation reactor 524 as a separate product stream from the gaseous product stream and removed from the system 100.

The carbon formation reactor 524 can form solid carbon that can be removed as a solids stream and a gaseous stream comprising CO, H₂O, H₂, and CO₂ and hydrocarbons. The reaction can result in an outlet temperature in the range of 400° C. to 700° C., and the solids stream can pass to one or more heat exchangers 526, 528 to cool the solids product. The first heat exchanger 526 can serve as a heat recovery steam generator to produce steam for use within the system. A further trim cooler 528 can be used to produce a solids stream 530 that can leave the system for further handling. The solids stream can comprise predominantly carbon with some amount of the catalytic material included (which in some aspects may be carbon). In some aspects, the mass ratio of the solid carbon to the catalytic material can be in the range of about 500:1 to about 2:1, or in a range of about 200:1 to about 100:1.

The gaseous products leaving the carbon formation reactor 524 can pass to a heat exchanger 532 to cool the products. As with the solid products, the high temperature gaseous products can be cooled in an exchanger 532 that can serve as a heat recovery steam generator to generate steam. The cooled gas stream can then pass to a condenser 534. The condenser 534 can be used to remove any excess water from the stream as condensed stream 536. Higher levels of water removal may require processes described previously herein. In the system 500 of FIG. 5, the addition of oxygen into reformer 512 can result in excess oxygen being present. The oxygen can leave the system as water in the condensed water stream so that the oxygen is removed as water rather than CO₂.

In some optional embodiments, a portion of the gaseous stream 535 passing out of the condenser 534 can pass back to the inlet stream 519 to the carbon formation reactor 524. A compressor or blower unit 538, which may include cooling for its feed and heating for its exhaust, can be used to recycle all or a portion of the gaseous stream 535 to the carbon formation reactor 524 inlet preheater 520. Gaseous stream 535 can comprise H₂, CO, CO₂, hydrocarbons, and unseparated H₂O. Stream 535 can have a higher H₂ to CO ratio than stream 519 produced from reformer 512. By recycling all or a portion of stream 535, the carbon formation reactor 524 can be operated at a higher H₂ to CO ratio than that produced by reformer 512.

A reverse water gas shift (rWGS) reactor 540 can be used to convert CO₂ in the gaseous product stream 535 to CO using H₂. The inlet stream 535 comprising CO₂, CO, H₂, and hydrocarbons can be heated in an optional exchanger before passing to the rWGS reactor 540. The exchanger can comprise any of the exchangers disclosed herein, and can heat the combined feed stream to a temperature of between about 200° C. to about 700° C., depending on the nature of the rWGS reactor 540.

The rWGS reactor can convert CO₂ to CO using H₂ according to the following equation:

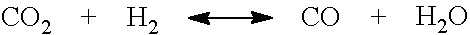

The rWGS reaction can be operated in the presence of one or more catalysts. Suitable catalyst can include those selected from the group consisting of ZnO, MnOx, alkaline earth metal oxides composite (or mixed metal) oxides. Further rWGS catalysts are known to those of skill in the art.

The rWGS reaction can be carried out in one or more suitable reactors such as an adiabatic or heated reactor. Reactor vessels such as fixed bed reactors, fluidized bed reactors, or the like can be used. For example, the rWGS reactor can comprise a fixed bed catalyst disposed in one or more tubular reactors configured in an adiabatic reactor or in a heat reactor with the tubular reactors being externally heated. The external heat can be provided by the carbon formation reactor 524, if it is exothermic, via direct heat exchange, steam, or any heat exchange method described herein. The rWGS reactor can be operated at a temperature in a range of from about 500° C. to about 800° C., and any suitable pressure used within the system such as between about 1 bar to about 50 bar, or between about 5 bar and about 20 bar. The conversion efficiency of CO₂ to CO can be above 30%.

In some optional embodiments, a stream 537 of catalyst can be passed through the rWGS reactor 540 during the reaction to form a reduced catalyst in stream 539. The resulting catalyst stream can then be passed back to the inlet of the carbon formation reactor 524 as stream 521. In this embodiment, the catalyst (e.g., fresh catalyst, catalyst with carbon from the carbon formation reactor 524, etc.) can be present within the rWGS reactor 540 during the reaction. Various species such as any oxygen containing species formed on the carbon or the catalyst can be reduced based on the presence of hydrogen and other species during the rWGS reaction. In some aspects, the resulting reduced catalyst may be more catalytically active than the catalyst entering the rWGS reactor 540, and can then be used within the carbon formation reactor 524 to further form carbon for removal from the system 500.

The stream leaving the rWGS reactor 540 can pass to a condenser 542 to remove at least a portion of the water produced in the rWGS reactor 540. The condenser 542 can be the same or similar to the condensers described herein. The resulting water stream 544 can then leave the system.

The remaining gas stream 541 from the condenser 542 can predominantly comprise CO₂, CO, H₂, and hydrocarbons, though some trace compounds may also be present. The hydrogen in the stream can be removed in a separator 546 to form hydrogen stream 548. As shown in FIG. 5, a pressure swing adsorption (PSA) unit 546 can be used to separate at least a portion of the hydrogen from the product stream from condenser 542. While shown as a PSA unit, other suitable separation units such as temperature swing adsorption, membrane units, and the like can also be used to separate at least a portion of the hydrogen. In some aspects, at least about 50%, at least about 60%, at least about 70%, at least about 80%, or at least about 90% of the hydrogen (by volume) in the product stream from the condenser 542 can be separated in the separation unit 546 to form the hydrogen product stream 548 and a recycle stream having a reduced hydrogen concentration.

The remaining hydrocarbons and CO₂ in the recycle stream can be compressed in compressor 550 and cooled in a heat exchanger to form stream 551, which can be recycled to the inlet of the reformer preheater 511 as described herein.

The overall system 500 can be used to convert a feed comprising hydrocarbon to produce solid carbon and hydrogen. A higher hydrogen output can be obtained by reducing or eliminating the amount of CO₂ provided to the reformer 512, and more CO₂ can be consumed to form carbon by limiting or eliminating the amount of hydrogen production. The addition of oxygen to allow the reforming reaction to operate in an autothermal manner can result in the introduction of additional oxygen that can be removed as water and/or CO₂, though removal as water may help to prevent the generation of CO₂ from the system.

In some aspects, the system can also be used to convert CO₂ introduced into the system into solid carbon and water, thereby capturing CO₂ as solid carbon. The conversion of CO₂ to carbon can be improved by not removing all or a portion of the hydrogen using the separator 546, for example, by all or a portion of the outlet stream of the condenser 542 to bypass the separator 546.

The various systems described herein also allow for the promotion of CO reduction in the carbon formation reaction 124, thus reducing CO₂ production via the Boudouard reaction. The overall process can consume a catalyst within the carbon formation reactor. However, the catalyst may be relatively low cost to allow the system to be cost effective.

The systems described herein can be configured to receive a hydrocarbon stream and produce hydrogen and a solid carbon stream. Oxygen can be present within the system and be used in the process to carry out the formation of solid carbon from the hydrocarbon. When oxygen is introduced into the system (e.g., in a catalyst used in a carbon formation process), the oxygen can be removed as a water stream and/or a CO₂ stream. The oxygen may be removed in a water stream in order to avoid the emission of CO₂ from the overall system.

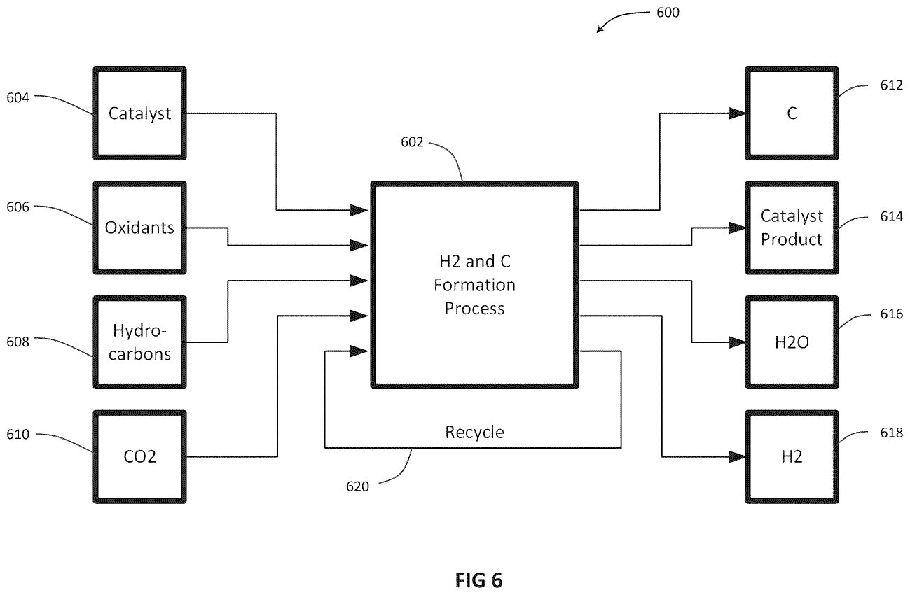

The disclosed systems can be used in various processes to carry out the formation of solid carbon from one or more hydrocarbons and/or CO₂. While specific systems have been disclosed, a more general process is shown in FIG. 6. As shown, a process for converting a stream comprising carbon (e.g., a hydrocarbon, a carbon oxide such as carbon dioxide, etc.) can be converted to solid carbon and a product stream comprising hydrogen when hydrogen is present in the feed stream.

FIG. 6 illustrates an embodiment of a system 600 for producing hydrogen and carbon. As shown, a reactor system 602 comprising one or more reactors can be configured to receive a feed stream comprising a hydrocarbon 608 and an oxidant 606 and produce products comprising solid carbon 612 and hydrogen gas 618. Any of the configurations described herein can be used to carry out the conversion of a hydrocarbon with an oxidant to produce hydrogen and solid carbon.

The oxidant can comprise any compound comprising oxygen such as CO₂, CO, O₂, H₂O or the like. While the oxidant stream 606 and the CO₂ stream 610 are shown as separate streams in FIG. 6, the CO₂ could be part of the oxidant stream 606. The hydrocarbons can include any of those described herein. The oxidant(s) in the oxidant stream can react with the hydrocarbon to produce one or more intermediates that can converted to hydrogen and solid carbon.

In some aspects, one or more catalyst 604 can be used with the reactor system 602. The catalyst can be used to produce one or more intermediates and/or solid carbon. For example, any of the catalytic reactions described herein to convert the reactants such as CO₂, H₂O, or a hydrocarbon into intermediates such as CO can use a catalyst. A catalyst can also be used to produce solid carbon. For example, an iron based catalyst can be used to produce solid carbon on the catalytic material, which can then be removed from the reactor. The products can the include a catalyst product 614 such as a catalyst having solid carbon disposed thereon.

In some aspects, the oxidant stream 606 can be converted within the reactor system 602 to produce water that can leave the system as a water stream 616. This process can then convert the oxygen entering the system to water rather than a carbon oxide, thereby limiting the emission of carbon as a gas such as CO₂. In some aspects, the oxidant can comprise CO₂ when introduced into the system, and the reactor system 602 can convert the CO₂ to solid carbon and water.

The reactor system 602 can be configured to operate autothermally or exothermically. This may be advantageous to limit the amount of heat that needs to be added into the reactors, which can simplify the heat transfer and heat additional processes within the reactor system.

As shown in FIG. 6, a recycle system 620 can be provided as part of the system 600. In some aspects, the recycle system 620 can comprise one or more separators to remove portions of the product stream from the reactor system 602 and recycle the separated components to an inlet of the reactor system 602. For example, any unreacted oxidants, or alternatively, any oxidants in the product stream other than water, may be separated and recycled into the inlet of the reactor system 602. As another example, any unreacted hydrocarbons may be separated and recycled. In some aspects, some amount of hydrogen may be recycled within the system as needed to aid in the formation of solid carbon.

As an example of a such a system, the hydrocarbon in hydrocarbon stream 608 may be methane, and the oxidant in stream 606 can comprise 02, H₂O, and/or CO₂. An iron based catalyst can be used in the reactor system, and the solid carbon can be formed on the iron based catalyst, which can then be removed from the system with the solid carbon product, as described in more detail in the embodiments disclosed herein. In such embodiments, the catalyst may be continually added to the reactor system, and the catalyst having the solid carbon disposed thereon may be continually removed from the reactor to provide a continuous reaction process. Further, the systems can operate according to any of the embodiments disclosed herein.

The various systems described herein also allow for the balancing of reforming reactions, Boudouard reaction, and CO reduction reaction to avoid the need for high temperature reaction media such as a molten metal and/or molten salt. For example, combining the reforming reactions with the carbon formation reactions can allow the reforming reactions to operate in an endothermic manner and the Boudouard reaction and CO reduction reaction as exothermic reactions to generate solid carbon. The overall process can consume a catalyst within the carbon formation reactor. However, the catalyst may be relatively low cost to allow the system to be cost effective.

The systems described herein can be configured to receive a hydrocarbon stream and produce hydrogen and a solid carbon stream. Oxygen can be present within the system and be used in the process to carry out the formation of solid carbon from the hydrocarbon. When oxygen is introduced into the system (e.g., in the catalyst used in a carbon formation process), the oxygen can be removed as a water stream and/or a CO₂ stream. The oxygen may be removed in a water stream in order to avoid the emission of CO₂ from the overall system.

The disclosed systems can be used in various processes to carry out the formation of solid carbon from one or more hydrocarbons and/or CO₂.

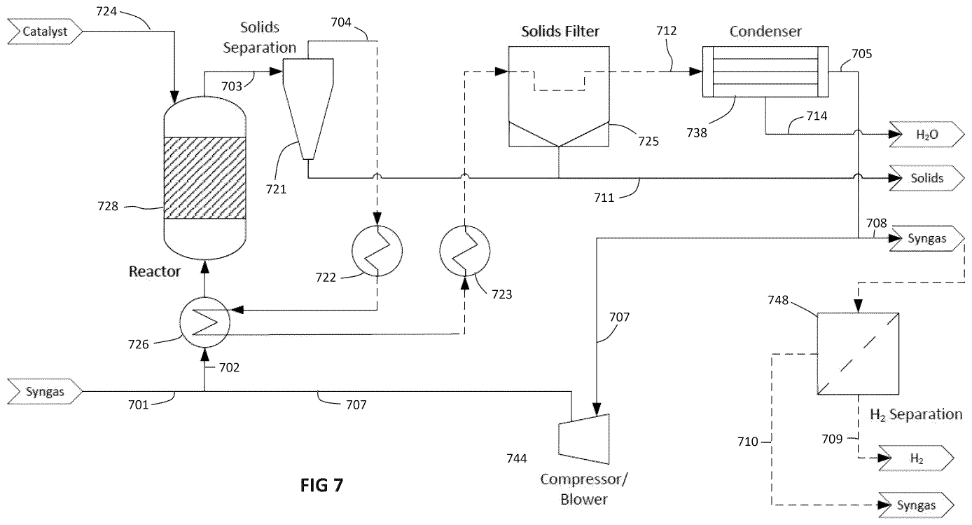

Various reactor systems can be used in any of the embodiments disclosed herein. The reactor systems can result in carbon monoxide reduction and other reactions such as those described herein (e.g., Boudouard reactions, etc.) using a catalytic reactor with a recycle stream. In addition to the embodiments disclosed herein, FIG. 7 illustrates an embodiment of a system and associated processes for reacting carbon monoxide and hydrogen to generate solid carbon and gaseous products.

As shown an input stream 701 can be passed to and combined with a recycle stream 707 before passing to a carbon formation reactor 728. The input stream 701 can comprise carbon monoxide and hydrogen, and the recycle stream 707 can also comprise carbon monoxide and hydrogen. In some aspects, the recycle stream 707 can be between about 20% to about 95%, or alternatively between about 50% and about 90%, by volume of the dehydrated stream 705. In some aspects, nearly all of the dehydrated stream 705 can be recycled, except for some amount that can be purged from the system. In these embodiments, the recycle stream 707 can be between about 20% to about 95%, or alternatively between about 50% and about 90%, by volume of the dehydrated stream 705.

The specific ratio of carbon monoxide to hydrogen in the combined stream 702 may be adjusted by feeding different hydrogen to carbon monoxide ratios in the input stream 701 or by adjusting the relative amounts of the input stream 701 and the recycle stream 707. In some aspects, the ratio of hydrogen to carbon monoxide by volume in the combined stream 702 can be between about 0.1:1 to about 10:1, between about 0.25:1 to about 5:1, or between about 1.5:1 to about 6:1. In some aspects, additional components such as carbon dioxide, water, and oxygen may be present in small or trace amounts.

In some embodiments, a hydrocarbon may be present in the input stream 701 and/or the recycle stream 707, or alternatively or additionally, a hydrocarbon may be added to either stream in a desired amount. The hydrocarbon can include any of those described herein. In some aspects, the presence of the hydrocarbon may suppress side reactions such as methanation within the carbon formation reactor to improve the overall process. When present, the hydrocarbon may be present in an amount of between about 1% to about 50% by volume of the combined stream 702, or at least about 10% by volume of the combined stream 702.

The combined feed stream 702 can then pass to a carbon formation feed preheater 726, which can be any suitable exchanger as described herein, including an indirect heat exchanger, a superheater, a gas-gas counterflow heat exchanger, or another heat exchanger. The feed to the carbon formation reactor 728 can be heated to a temperature between about 200° C. to about 750° C. before passing to the carbon formation reactor 728. The carbon formation reactor 728 can be the same as carbon formation reactor 110 or the carbon formation reactor 250 described with respect to FIGS. 1-5. A catalyst in stream 724 can be passed to the carbon formation reactor 728 for use in forming solid carbon. The catalyst can include any of the catalyst(s) described with respect to stream 112 or stream 248 in FIGS. 1 and 2. In some aspects, heat integration may be used to provide a more energy efficient system. As shown in FIG. 7, the carbon formation feed preheater 726 may allow indirect heat exchange between the combined feed stream 702 and the hotter product stream 704 to heat the combined feed stream 702 and cool the product stream 704.

The carbon formation reactor 728 can carry out any of the reactions described with respect to FIG. 1 in the presence and in contact with the solid catalyst to form solid carbon that can be removed as a solids stream and a gaseous stream comprising CO, H₂O, H₂, and CO₂. When the feed predominantly comprises carbon monoxide and hydrogen, the product may comprise solid carbon formed on the catalyst and water, though a number of additional reactions occurring within the reactor may product various by-products such as carbon dioxide, hydrogen, methane, and the like. The catalyst can comprise any of the catalysts described herein such as elemental, oxides, or carbides of various metals such as iron, cobalt, or nickel. The carbon formation reactor 728 can operate at a temperature in the reaction zone between about 500° C. and about 900° C., or between about 650° C. and about 800° C. The reaction can result in an outlet temperature in the range of 400-800° C. The carbon formation reactor 728 can operate at a pressure between about 1 bar and about 80 bar, or between about 5 bar and about 40 bar, or between about 10 bar, and about 20 bar.

The conversion across the reactor can vary based on the composition of the feed stream and the reaction conditions. In some aspects, the carbon monoxide conversion in the reactor from the combined stream 702 to the product stream 703 can be up to and including about 60%. In some aspects, the carbon dioxide conversion in the reactor from the combined stream 702 to the product stream 703 can be up to and including about 70%. In some aspects, the hydrogen conversion in the reactor from the combined stream 702 to the product stream 703 can be up to and including about 30%.

In some embodiments, the carbon formation reactor 728 can be thermally controlled during the reaction. Various direct and indirect heat exchange can be used during the reaction. For example, control of the inlet gas temperature, using liquid water, boiling water, saturated or supersaturated steam, use of external heat exchange such as cooling jackets, and the like can be used to control the temperature of the carbon formation reactor 728 during the reaction. In some aspects, additional reactions can be used to control the temperature within the carbon formation reactor 728 such as using endothermic reforming reactions that convert a hydrocarbon to a syngas stream comprising carbon monoxide and hydrogen occurring in heat exchange tubes within the reactor. In some aspects, the carbon formation reactor 728 can be cooled during the reaction.

The products and unreacted reactants, including the catalyst and solid carbon products, can leave the carbon formation reactor 728 in stream 703. Since the solids are entrained within the gas stream, the entire product stream 703 can pass to a solids separator 721 to separate at least a portion of the solids, including the solid carbon and the solid catalyst, from the product stream 703. Any suitable solids separator can be used such as a cyclone, bag house, filter, and the like. While a single solids separator 721 is shown in FIG. 7, and number of solids separators arranged in series and/or parallel can be used to handle the anticipated volume of gas and solids. A portion of the solids from the separated solids stream 711 may be recycled to the carbon formation reactor 728. Some solids may also be removed separately, from the bottom of the reactor.

The solids separator 721 may then result in a solids stream 711 that can pass out of the system. In some aspects, the solids stream can comprise solid carbon formed on the catalyst. The solid products can be used in the form as produced, and/or one or more additional processes can be used to remove at least a portion of the carbon from the catalyst to allow the catalyst, or a portion thereof, to be reused and returned to the carbon formation reactor 728. The amount of carbon formed in the carbon formation reactor 728 may be based on the amount of catalyst passed through the carbon formation reactor 728. In some aspects, a ratio of the carbon to catalyst can be between about 2:1 to about 200:1 by mass, or alternatively between about 10:1 to about 50:1 by mass. In some aspects, a ratio of the carbon to iron in the catalyst can be between about 2:1 to about 200:1 by mass, or alternatively between about 5:1 to about 50:1 by mass.

The remaining gas product stream 704 can then pass to one or more heat exchangers 722, 723 to further cool the gas product stream 704. The gas product stream 704 can comprise hydrogen, carbon monoxide, carbon dioxide, and water, where some amount of hydrocarbons may be present when hydrocarbons are present in the feed stream. In some aspects, the gas product stream can pass to an exchanger such as the carbon formation feed preheater 726 to provide heat integration to the system. One or more additional heat exchangers 722, 723 may provide trim cooling to the gas product stream 704 to produce a desired temperature output for the gas product stream 704.

The cooled gas product stream can then pass to an optional additional solids separator 725. Any suitable solids separation device such as one or more cyclones, bag houses, filters, or the like can be used to further remove solids from the cooled gas products stream. The separated solids can be combined with the solids in stream 711, or can be dealt with separately.

The cooled, solids-free gas product stream 712 can then pass to a condenser 738, which can be used to remove and separate at least a portion of the water from the stream 712. The condensed water can then pass out of the condenser 738 as stream 714. The remaining gas stream from the condenser can comprise a dehydrated stream 705. The dehydrated stream can comprise carbon monoxide, hydrogen, and some amount of carbon dioxide. In some aspects, a hydrocarbon such as methane may be present in the feed gas, and the resulting dehydrated stream may comprise some amount of hydrocarbon as an unreacted component. In some embodiments, the dehydrated stream 705 can have between about 5% to 40% carbon monoxide, 20-60% hydrogen, 0.5-15% carbon dioxide, and optionally 0-50% hydrocarbon, all by volume.

The dehydrated stream 705 can optionally be split with a first portion forming the recycle stream 707 and a second portion forming an outlet stream 708. The first portion can be sent to a compressor, blower, series of compressors, or series of blowers 744 before being combined with the feed stream 701. The relative amount of the recycle stream 707 combined with the feed stream 701 may be based, at least in part, on the composition of the feed stream 701 and the recycle stream 707.

The outlet stream 708 can be passed to an optional hydrogen separation unit 748, where at least a portion of the hydrogen can be separated from the remaining components. The hydrogen separation unit 748 can be the same or similar to the separator 126 described with respect to FIG. 1, including for example, an adsorption unit (e.g. a pressure swing adsorption unit, a temperature swing adsorption unit, etc.). The separated hydrogen can leave the system as hydrogen stream 709. The remaining components, including predominantly unreacted hydrocarbon and CO, can be passed out of the system as stream 710. When the stream 710 is used within the system, a portion of the stream 710 may be purged (e.g., to atmosphere) to prevent a buildup of inert gases in the system. When a portion is purged, the portion may be from about 1% to about 20% by volume, or in some aspects, less than about 15% or less than about 10% by volume. In some aspects, the hydrogen separation unit 748 may be used to adjust the relative amounts of the components in the syngas 708, for example, by increasing a carbon monoxide to hydrogen ratio. This may allow stream 710 to be used within any of the reaction systems described herein, or any other process accepting syngas as a feed gas.

While not shown in FIG. 7, additional solids separation may be used with any of the streams within the system that are downstream of the carbon formation reactor 728. For example, any of the solids separators described herein can be used downstream of the condenser, the H₂ separator, or any other units. The resulting solids streams can be combined with the solids stream or otherwise removed from the system.

Based on the recycle stream and the separation of the solids, the system and process described with respect to FIG. 7, may operate free or substantially free of direct CO₂ emissions. For example, the only CO₂ emissions may occur due to the purge stream to avoid the build-up of inert gases within the system. In some aspects, the system may operate with direct CO, CO₂, and CH₄ emissions at a level of less than 3 kg CO₂e/kg H₂ produced, or alternatively at a level of less than 1 kg CO₂e/kg H₂ produced. In some embodiments, the purge stream is flared with air to convert CO and CH₄ to CO₂ which can reduce CO₂-equivalent emissions.

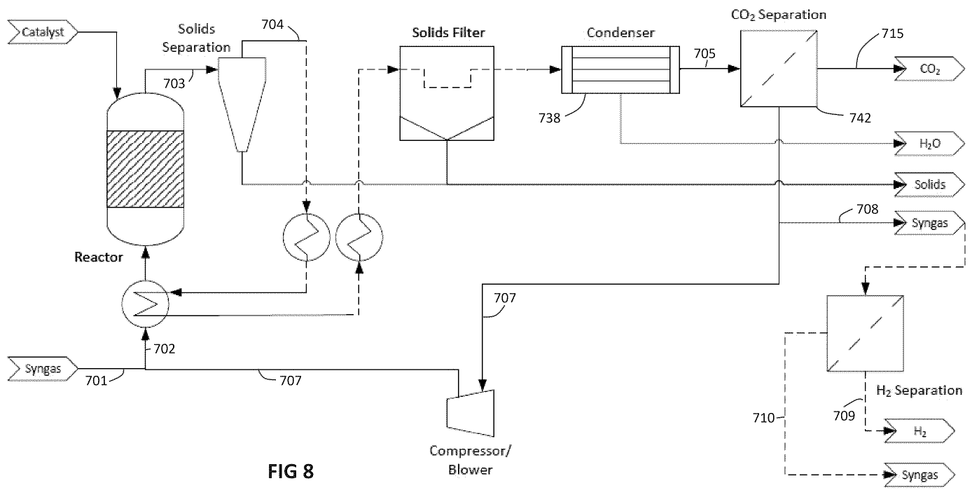

A similar reaction system is shown in FIG. 8. The main difference between FIG. 7 and FIG. 8 is the addition of a carbon dioxide separation unit for separating at least a portion of the carbon dioxide from the dehydrated stream 705. As shown in FIG. 8, the dehydrated stream 705 passing out of the condenser 738 can pass to a CO₂ separation unit 742 to remove at least a portion of the CO₂ from the stream. The CO₂ separation unit 742 can be the same or similar to the CO₂ removal unit 226 as described with respect to FIG. 2, and can comprise any suitable units and processes for removing CO₂. The removed CO₂ in stream 705 can be passed out of the system as CO₂ stream 715. The remainder of the gas stream can be split into the first portion 707 forming the recycle stream and a second portion 708 forming the outlet stream, each of which can be processed as described with respect to FIG. 7. The use of the CO₂ separation unit 742 may allow the composition of the dehydrated stream 705 to be adjusted while also producing a purified CO₂ stream.

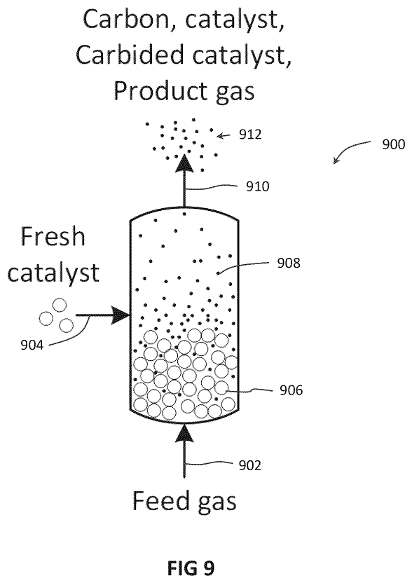

FIG. 9 illustrates a carbon formation reactor 900. The carbon formation reactor 900 can be used in any of the embodiments disclosed herein, including any of those described with respect to FIGS. 1-8. As illustrates, a feed gas stream 902 can be fed into the carbon formation reactor 900, which can contain a solid catalyst 906. The solid catalyst 906 can be introduced into the process as a solids stream 904. Within the carbon formation reactor 900, the solid catalyst 906 can form a bed where the components of the feed stream 902 can react to form solid carbon on the solid catalyst 906. A portion of the solid carbon 908 can be removed from the solid catalyst 906 and entrained with the gas stream 910 out of the reactor. The solid carbon 912 can then be separated in one or more downstream units.

The feed stream 902 can comprise any of the feed streams passing to a carbon formation reactor as described herein. The feed stream can comprise carbon monoxide and hydrogen, and optionally, carbon dioxide and/or a hydrocarbon including any of those described herein. In some aspects, additional components such as oxygen and/or water may also be present in the feed stream 902. In some aspects, the ratio of hydrogen to carbon monoxide by volume in the feed stream 902 can be between about 1.5:1 to about 6:1. In some aspects, the hydrogen gas to carbon monoxide ratio (H₂/CO) in the feed stream 902 can be at least about 0.1, at least about 0.25, at least about 1, or at least about 1.5, and/or the hydrogen gas to carbon monoxide ratio (H₂/CO) in the feed stream 902 can be less than about 10, less than about 8, less than about 6, less than about 4, or less than about 2. When present, the hydrocarbon may be present in an amount of between about 1% to about 50% by volume of the combined stream 902, or at least about 10% by volume of the combined stream 902.

The catalyst introduced into the carbon formation reactor 900 in solids stream 904 can include any of the catalyst(s) described with respect to stream 112 or stream 248 in FIGS. 1 and 2. In some aspects, the catalyst can include any material suitable for catalyzing the formation of the solid carbon material from the carbon oxide and the gaseous reducing material. As an example, the catalyst material may be an element of Group VI, Group VII, Group VIII, Group IX, or Group X of the Periodic Table of Elements (e.g., iron, nickel, molybdenum, platinum, chromium, cobalt, tungsten, vanadium, titanium, tantalum, zirconium, hafnium, etc.), an actinide, a lanthanide, oxides thereof, carbides thereof, alloys thereof, or combinations thereof. In some aspects, the catalyst may be unsupported such that the catalytic component is not placed or supported on another material.

Within the carbon formation reactor 900, the catalyst can take a variety of forms such as a fixed bed reactor, a fluidized bed reactor, a spouting bed reactor, a moving bed reactor, circulating fluidized bed, or the like. The carbon formation reactor can operate under any of the conditions such as temperature, pressure, and residence time as described herein. For example, the reaction may occur at a temperature between about 400° C. and about 1000° C., or between about 550° C. to about 900° C., or between about 650° C. to about 800° C., and the reaction may occur at a pressure between about 1 and 40 bar, between about 1 and 20 bar, or between about 5 and 15 bar.

During the reaction, solid carbon may be formed on the catalyst particles and form a layer of solid carbon. Additional reaction products such as hydrogen and other products can be produced as described in more detail with respect to the various embodiments disclosed herein. The reaction products can be processed in any of the systems as described herein.

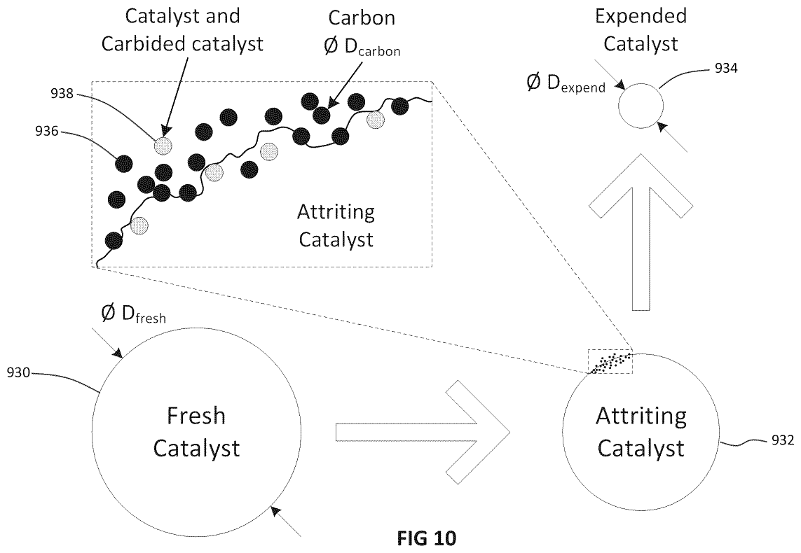

In some aspects, the catalyst particles can form a mobile bed such as a fluidized bed or a spouting bed in which the particles move relative to each other. For example, at least about 20%, at least about 40%, or at least about 50% of the solid material in the reactor may be fluidized by the gas phase. The relative movement of the catalyst particles can cause attrition of the catalyst as well as the carbon formed on the catalysts. Additionally, the particles can disintegrate by metal dusting (CO reduction and Boudouard reactions) heterogeneous chemical reactions as shown schematically in FIG. 10. As illustrated, a fresh catalyst particle 930 can have an initial diameter. While shown as being round or spherical, the catalyst particle may take a variety of shapes, and collectively, the catalyst particles can have an initial average catalyst diameter. The Sauter mean diameter may be used to represent the average diameter of an equivalent spherical particle and can be used to understand the fluidization and entrainment of the particulates. As the reaction progresses, solid carbon can be formed on the catalyst as an outer layer while disintegrating the catalyst. As the catalyst particles move relative to each other, attrition of the catalyst and the solid carbon can occur. This process is illustrated schematically with small catalyst particulates 938 and solid carbon particulates 936 being removed from the outer surface of the catalyst particle 932 through disintegration and attrition. The overall process can result in a decrease in the average diameter of the catalyst particle as demonstrated by the catalyst particle diameter being smaller for catalyst particle 932 than that of initial catalyst particle 930. As the process continues, the catalyst particle may eventually have a decreased diameter reaching a certain minimum size, at which time the catalyst particle 934 may be considered to be expended.

Returning to FIG. 9, the relative size differences between the catalyst particles as disintegration and attrition occurs and the particulates removed from the catalyst particles can be used to selectively remove the solid products from the reactor using the feed and product gas flow rates to fluidize and entrain the product particulates. The solid products can be removed continuously or in a semi-batch or batch process. For example, the gas velocity through the reactor could periodically be increased to remove the solid particulates in a batch or semi-batch manner, or the gas flow rate could be selected along with the geometry of the reactor to have a continuously entrained stream of particulates of a desired size. While not shown, a solid outlet may also be present in the reactor to remove a portion of the solid product and/or catalyst particles from a lower portion of the reactor.

In addition to the gas phase flow rate, the density of the solid carbon and catalyst particulates and the geometry of the carbon formation reactor can be used to selectively remove particulates having an average diameter below a certain size from the carbon formation reactor. In some aspects, the internal diameter of the reactor can increase above the bed of particulates (i.e. the freeboard) to provide a lower gas velocity to allow larger particles to settle back to the upper surface of the bed. In some aspects, the carbon formation reactor can have a conical or increasing diameter towards an upper end of the reactor. In some aspects, the internal diameter of the carbon formation reactor 900 can increase to a final diameter and then maintain the diameter to an upper end of the vessel. The shape and rate of expansion of the internal diameter can be selected to provide for a desired residence time of the solid particles entrained in the gas phase to allow proper size selection of the particles 912 remaining in the gas phase and being removed from the carbon formation reactor in stream 910.

The ability to remove the particulates can allow the solid products and a portion of the catalyst material to be removed from the carbon formation reactor based on size and density differences of the particles resulting from the disintegration via heterogeneous chemical reaction and natural attrition of the particles moving relative to each other. In some aspects, the solids entrained in the product stream 910 can have a Sauter mean diameter that is at least about 2 times smaller than the Sauter mean diameter of the solid catalyst particles in the carbon formation reactor. For example, the catalyst entering the carbon formation reactor 900 in solids stream 904 can have a Sauter mean diameter between about 50 and 500 μm, or between about 100 and 300 μm. The solid phase comprising the catalyst and the solid carbon on the catalyst particles within the carbon formation reactor can have a Sauter mean diameter between about 20 and 400 μm, or between about 50 and 250 μm. The solid particulates, including solid carbon particulates and/or solid catalyst particulates resulting from chemical disintegration or attrition of the catalyst and solid carbon on the catalysts, can have a Sauter mean diameter between about 0.01 μm and 100 μm, or between about 0.1 μm and about 1 μm.

The relative amount of carbon removed in the particulate stream can be larger than the amount of catalyst removed. For example, the process may result in a solid phase being removed from the carbon formation reactor as an entrained stream, where the solid phase can include the solid carbon particulates and the solid catalyst particulates. The solid phase removed from the reactor can be more than about 50 wt. % carbon, or greater than about 80 wt. % carbon. Within the reactor, the solid phase that includes the solid carbon particulates, and the solid catalyst particulates, and the solid catalyst particles having carbon formed thereon during the reaction. The solid phase within the reactor can comprise less than about 50 wt. % carbon, less than about 30 wt. % carbon, or less than about 20 wt. % carbon.

Once removed from the carbon formation reactor 900 in the product stream 910, the entrained solids 912 can be separated using any of the separation devices described herein such as a cyclone, bag house, filter, or the like. The resulting solids stream from the separator can then be further processed. It is expected that some amount of the solids in the solids stream can comprise the catalytic material, and it may be useful to recycle or return at least a portion of the catalytic material into the carbon formation reactor 900 to allow for further formation of the solid carbon. In order to return the solid catalyst, at least a portion of the solids leaving the carbon formation reactor 900 may be separated and returned to the carbon formation reactor 900 as part of the solids stream 904 and/or as a separate solids inlet stream into the carbon formation reactor.

Size selection can be used to provide the portion of the separated solids returned or recycled to the carbon formation reactor. In some aspects, the portion returned to the carbon formation reactor can have a larger Sauter mean diameter than the rest of the solids in the product stream leaving the carbon formation reactor. For example, the portion of the solid products returned to the carbon formation reactor may represent the largest 10%, the largest 20%, or the largest 30% of the solids removed from the carbon formation reactor as measured by the average Sauter mean diameter of the solids in the product stream. The large particles may also represent a portion of the solids having a higher mass percentage of catalyst. In some aspects, the portion of the solids stream returned or recycled to the carbon formation reactor can have a higher catalyst to carbon mass ratio than the rest of the solid product stream.

The carbon formation reactor 900 can be used to perform any of the carbon formation reactions as described herein. In some aspects, the carbon formation reactor 900 can be used to react a feed stream comprising hydrogen and carbon monoxide to form a gaseous product comprising hydrogen, carbon monoxide, and carbon dioxide as well as a solid carbon product stream. A solid phase can be present in the reactor during the reaction that comprises a solid catalyst having the solid carbon product formed thereon. In some aspects, the catalyst can form a fluidized bed. Any of the catalyst described herein can be used, and in some embodiments, the catalyst can comprise iron, an iron oxide, or an iron carbide (e.g., Fe₃C). The solid phase comprising the solid catalyst and the solid carbon can have less than about 50 wt. % carbon. The movement of the solids in the fluidized bed can result in the formation of separate particulates of carbon and the solid catalyst. The particulates can be entrained in the gas phase leaving the carbon formation reactor. The solids leaving the carbon formation reactor can be at least about 50 wt. % carbon, and/or the solids can have a Sauter mean diameter of at least about 50% smaller than the solid phase particles in the fluidized bed that are not entrained in the gas phase.

### EXAMPLES

The disclosure having been generally described, the following examples are given as particular embodiments of the disclosure and to demonstrate the practice and advantages thereof. It is understood that the examples are given by way of illustration and are not intended to limit the specification or the claims in any manner.

### Example 1

### Converting CO and H₂ on a Fe Catalyst

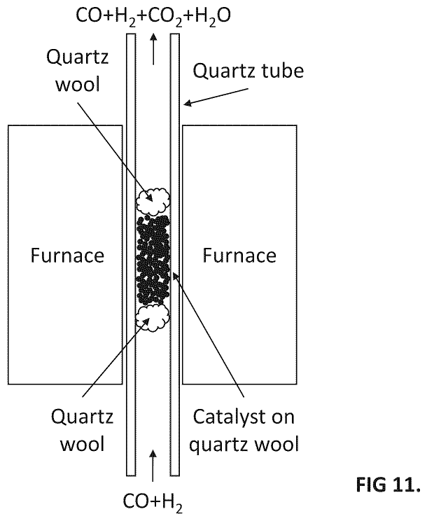

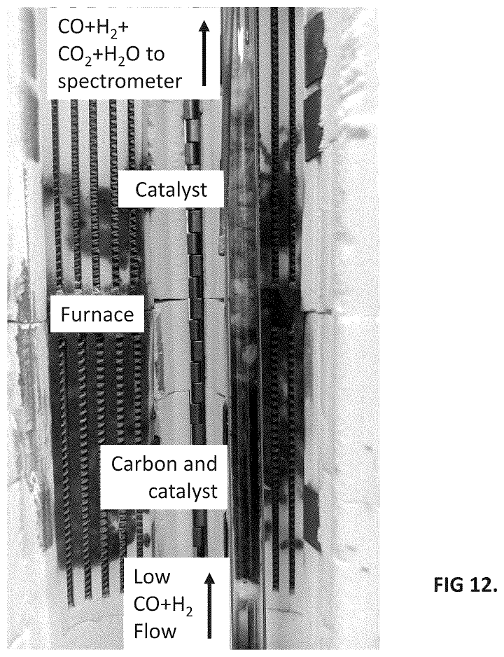

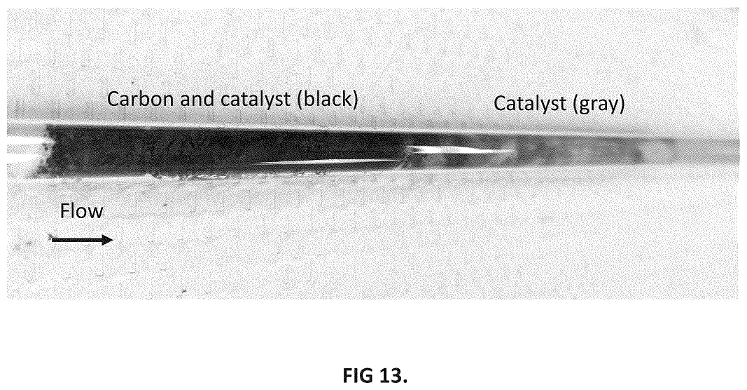

In a specific example, a fixed bed packed with Fe catalyst on quartz wool is operated at 650° C. for 10 hours producing C, CO₂, and H₂O from CO and H₂ reactants as shown schematically in FIG. 11. FIG. 12 shows the experimental setup during a run, with carbon deposited on part of the catalyst. The CO conversion is over 50% and the final C to Fe weight ratio is 10. Carbon largely deposits at the beginning of the catalyst charge as shown in FIG. 13.

Having described various systems, processes, and compositions, certain aspects can include, but are not limited to:

A first aspect can include a process for the reaction of a hydrocarbon comprising reacting a hydrocarbon with oxygen to produce a gas stream and a solid stream in a reactor, wherein the gas stream comprises hydrogen, water, and carbon oxides, and wherein the solid stream comprises solid carbon; and separating the gas stream from the solid stream.

A second aspect can include the process of the first aspect, wherein reacting the hydrocarbon with the oxygen to produce the gas stream and the solid stream occurs autothermally or substantially autothermally.

A third aspect can include the process of the first or second aspect, further comprising: separating the water and hydrogen from the gas stream to form a second gas stream, wherein the second gas stream comprises the carbon oxides; and recycling the second gas stream back to the reactor.

A fourth aspect can include the process of any one of the first to third aspects, wherein the hydrocarbon is a light alkane, coal, biomass, an alcohol, naphtha, crude oil, or any combination thereof.

A fifth aspect can include the process of any one of the first to fourth aspects, further comprising: introducing carbon dioxide into the reactor, wherein at least a portion of the carbon dioxide is reacted with the hydrocarbon, the oxygen, the hydrogen, the water, the carbon oxides, or any combination thereof.

A sixth aspect can include the process of any one of the first to fifth aspects, wherein the reacting comprises using a solid catalyst in the reactor.

A seventh aspect can include the process of the sixth aspect, wherein the solid catalyst comprises an element of Group VI, Group VII, Group VIII, Group IX, or Group X, an actinide, a lanthanide, oxides thereof, alloys thereof, or combinations thereof.

An eighth aspect can include the process of the sixth or seventh aspect, further comprising: forming the solid carbon on the solid catalyst, wherein the solid stream further comprises at least a portion of the solid catalyst.

A ninth aspect can include the process of any one of the first to eighth aspects, wherein at least a portion of the oxygen is converted to the water in the reacting, and wherein the water is removed from the process.

A tenth aspect can include the process of any one of the first to ninth aspects, wherein the process is free from CO₂ emissions.

In an eleventh aspect, a process for the reaction of a hydrocarbon comprises: reacting a first portion of a first hydrocarbon with one or more oxygen-containing species in a first reactor to produce a first product stream comprising a first portion of hydrogen, water, and carbon oxides; separating the water from the first product stream; separating the carbon dioxide from the first product stream and recycling to the first reactor; reacting the remaining first product stream with a second portion of second hydrocarbon in a second reactor to produce solid carbon, hydrogen, water, and carbon oxides; separating the solid carbon from the second gas product stream; separating the water from the second gas product stream; separating the hydrogen from the second gas product stream and recycling the remaining second gas product stream to the first reactor.

A twelfth aspect can include the process of the eleventh aspect, wherein the first portion of the first hydrocarbon and the second portion of the second hydrocarbon have the same composition.

A thirteenth aspect can include the process of the eleventh or twelfth aspect, wherein the first portion of the first hydrocarbon and the second portion of the second hydrocarbon have different compositions.

A fourteenth aspect can include the process of any one of the eleventh to thirteenth aspects, wherein reacting the first portion of the first hydrocarbon with the one or more oxygen-containing species in the first reactor comprises: reacting the first portion of the first hydrocarbon with carbon dioxide to produce carbon monoxide and hydrogen.

A fifteenth aspect can include the process of the fourteenth aspect, wherein the reacting of the first portion of the first hydrocarbon occurs in the substantial absence of water.

A sixteenth aspect can include the process of any one of the eleventh to thirteenth aspects, wherein reacting the first portion of the first hydrocarbon with the one or more oxygen-containing species in the first reactor comprises: reacting the first portion of the first hydrocarbon with water to produce carbon monoxide and hydrogen.

A seventeenth aspect can include the process of any one of the eleventh to sixteenth aspects, wherein reacting the first portion of the first hydrocarbon with the one or more oxygen-containing species in the first reactor comprises: introducing oxygen into the first reactor with the first portion of the first hydrocarbon;

An eighteenth aspect can include the process of any one of the eleventh to seventeenth aspects, further comprising: separating at least a portion of the first portion of hydrogen from the first reactor product stream prior to reacting the stream with the second portion of the second hydrocarbon.

A nineteenth aspect can include the process of any one of the eleventh to eighteenth aspects, wherein the reacting of the first reactor product stream with the second portion of the second hydrocarbon further produces carbon dioxide, and wherein the process further comprises: separating at least a portion of the second portion of the hydrogen from the carbon dioxide.

A twentieth aspect can include the process of any one of the eleventh to nineteenth aspects, wherein the reacting of the first reactor product stream with the second portion of the second hydrocarbon occurs in the presence of a solid catalyst.

A twenty first aspect can include the process of the twentieth aspect, wherein the solid catalyst comprises an element of Group VI, Group VII, Group VIII, Group IX, or Group X, an actinide, a lanthanide, oxides thereof, alloys thereof, or combinations thereof.

A twenty second aspect can include the process of any one of the eleventh to twenty first aspects, wherein the reacting in the first reactor occurs autothermally or substantially autothermally.

A twenty third aspect can include the process of any one of the eleventh to twenty first aspects, wherein the reacting in the second reactor occurs autothermally or substantially autothermally.

A twenty fourth aspect can include the process of any one of the eleventh to twenty third aspects, wherein the reacting of the first reactor product stream with the second portion of the second hydrocarbon produces a product gas stream comprising the hydrogen, carbon monoxide, and water, wherein the process further comprises: reacting the product gas stream in a water gas shift reactor to convert at least a portion of the carbon monoxide and water to carbon dioxide and hydrogen.

A twenty fifth aspect can include the process of any one of the eleventh to twenty fourth aspects, wherein the first portion of the hydrocarbon, the second portion of the hydrocarbon, or both comprise a light alkane, coal, biomass, an alcohol, naphtha, crude oil, or any combination thereof.

A twenty sixth aspect can include the process of the eleventh aspect, wherein the first hydrocarbon comprises methane, wherein the one or more oxygen-containing species comprise carbon dioxide, wherein reacting the first reactor product stream in the second reactor comprises reacting the carbon monoxide in the second reactor, wherein the reacting of the carbon oxides with the second portion of the second hydrocarbon in the second reactor occurs in the presence of a solid catalyst comprising iron and produces a solid product stream comprising the solid carbon, and wherein the solid product stream further comprises iron and iron carbide.

A twenty seventh aspect can include the process of the eleventh aspect, wherein the first hydrocarbon comprises biomass, wherein the one or more oxygen-containing species comprise oxygen, reacting the first reactor product stream in the second reactor comprises reacting the carbon monoxide in the second reactor, wherein the reacting of the carbon oxides with the second portion of the second hydrocarbon in the second reactor occurs in the presence of a solid catalyst comprising iron and produces a solid product stream comprising the solid carbon, and wherein the solid product stream further comprises iron and iron carbide.

In a twenty eighth aspect, a process comprises: reacting carbon dioxide with hydrogen to produce a first product stream comprising carbon dioxide, carbon monoxide, and water; separating the carbon monoxide and water from the first product stream; and reacting the carbon monoxide with a portion of hydrocarbons in a carbon formation reactor to produce a second product stream and a solid product stream, wherein the solid product stream comprises solid carbon.

A twenty ninth aspect can include the process of the twenty eighth aspect, wherein reacting the carbon dioxide with the hydrogen occurs in a reverse water gas shift reactor, and wherein the process further comprises: recycling the carbon dioxide and hydrogen from the first product stream to the reverse water gas shift reactor.

A thirtieth aspect can include the process of the twenty eighth or twenty ninth aspect, wherein the second product stream comprises water, carbon monoxide, carbon dioxide and hydrogen, wherein the process further comprises: separating the water from the second product stream to produce a third product stream; separating the carbon monoxide and hydrogen from the third product stream; recycling at least a portion of the hydrogen from the third product stream to the reverse water gas shift reactor; recycling the carbon monoxide and any hydrocarbons to the carbon formation reactor; and recycling the carbon dioxide from the second product stream to the reverse water gas shift reactor.

A thirty first aspect can include the process of any one of the twenty eighth to thirtieth aspects, further comprising: introducing oxygen into the carbon formation reactor with the carbon monoxide and the portion of the hydrocarbons.

A thirty second aspect can include the process of any one of the twenty eighth to thirty first aspects, wherein reacting the carbon monoxide with the portion of the hydrocarbons in the carbon formation reactor occurs in the presence of a solid catalyst.

A thirty third aspect can include the process of the thirty second aspect, wherein the solid catalyst comprises an element of Group VI, Group VII, Group VIII, Group IX, or Group X, an actinide, a lanthanide, oxides thereof, alloys thereof, or combinations thereof.

A thirty fourth aspect can include the process of any one of the twenty eighth to thirty third aspects, wherein reacting the carbon monoxide with the portion of hydrocarbons in the carbon formation reactor occurs autothermally or nearly autothermally.

A thirty fifth aspect can include the process of any one of the twenty eighth to thirty fourth aspects, further comprising: cooling the second product stream leaving the carbon formation reactor; and reacting the water and the carbon monoxide in the second product stream in a water gas shift reactor.

A thirty sixth aspect can include the process of any one of the twenty eighth to thirty fifth aspects, wherein the portion of the hydrocarbon comprises a light alkane, coal, biomass, an alcohol, naphtha, crude oil, or any combination thereof.

In a thirty seventh aspect, a process for the reaction of a carbon dioxide comprises: electrolyzing carbon dioxide in an electrolyzer to form a product stream comprising carbon dioxide, carbon monoxide, and oxygen; separating the carbon dioxide from the product stream; recycling the carbon dioxide to the electrolyzer; reacting the carbon monoxide with a portion of hydrocarbons in a carbon formation reactor; producing a second product stream and a solid product stream from the carbon formation reactor, wherein the solid product stream comprises solid carbon.

A thirty eighth aspect can include the process of the thirty seventh aspect, wherein the second product stream comprises water, carbon dioxide, carbon monoxide, and hydrogen, wherein the process further comprises: separating the water, the carbon dioxide, and the hydrogen from the second product stream; and recycling the carbon monoxide and the hydrocarbons from the second product stream to the carbon formation reactor.

A thirty ninth aspect can include the process of the thirty seventh or thirty eighth aspect, further comprising: introducing oxygen into the carbon formation reactor.

A fortieth aspect can include the process of any one of the thirty seventh to thirty ninth aspects, wherein reacting the carbon monoxide with the portion of hydrocarbons in the carbon formation reactor occurs in the presence of a solid catalyst.

A forty first aspect can include the process of the fortieth aspect, wherein the solid catalyst comprises an element of Group VI, Group VII, Group VIII, Group IX, or Group X, an actinide, a lanthanide, oxides thereof, alloys thereof, or combinations thereof.

A forty second aspect can include the process of any one of the thirty seventh to forty first aspects, wherein reacting the carbon monoxide with the portion of hydrocarbons in the carbon formation reactor occurs autothermally or substantially autothermally.

A forty third aspect can include the process of any one of the thirty seventh to forty second aspects, further comprising: cooling the second product stream leaving the carbon formation reactor; and reacting the water and the carbon monoxide in the second product stream in a water gas shift reactor.

A forty fourth aspect can include the process of any one of the thirty seventh to forty third aspects, wherein the portion of the hydrocarbon comprises a light alkane, coal, biomass, an alcohol, naphtha, crude oil, or any combination thereof.

In a forty fifth aspect, a process for the reaction of a hydrocarbon comprises: reacting a hydrocarbon with one or more oxygen-containing species in a first reactor to produce a first product stream comprising hydrogen, water, and carbon oxides; separating water from the first product stream; reacting the hydrogen and carbon oxides in a second reactor to produce a second product stream of solid carbon, water, hydrogen, and carbon oxides; separating the solid carbon from the hydrogen, water, and carbon oxides; and separating the water from the hydrogen and carbon oxides.

A forty sixth aspect can include the process of the forty fifth aspect, wherein the carbon oxides comprise carbon monoxide and carbon dioxide, where the process further comprises: separating hydrogen from the second product stream to produce a third product stream of mostly carbon oxides; and recycling the third product stream of mostly carbon oxides to the first reactor to react with the hydrocarbon.

A forty seventh aspect can include the process of the forty fifth or forty sixth aspect, wherein carbon monoxide is separated from the second product stream; and recycling the carbon monoxide to the second reactor.

A forty eighth aspect can include the process of any one of the forty fifth to forty seventh aspects, wherein hydrocarbon is present in at least one of the first product stream, the second product stream, or the third product stream, wherein the process further comprises separating and recycling the hydrocarbon to the first reactor, the second reactor, or both.

A forty ninth aspect can include the process of any one of the forty fifth to forty eighth aspects, wherein reacting the hydrocarbons with the one or more oxygen-containing species in the first reactor comprises: reacting the hydrocarbon with carbon dioxide.

A fiftieth aspect can include the process of the forty ninth aspect, wherein the reacting of the hydrocarbon occurs in the substantial absence of water.

A fifty first aspect can include the process of any one of the forty fifth to forty eighth aspects, wherein reacting the first portion of the first hydrocarbon with the one or more oxygen-containing species in the first reactor comprises: reacting the hydrocarbon with water to produce carbon monoxide and hydrogen.

A fifty second aspect can include the process of any one of the forty fifth to fifty first aspects, wherein reacting the hydrocarbon with the one or more oxygen-containing species in the first reactor comprises: introducing oxygen into the first reactor with the hydrocarbon;

A fifty third aspect can include the process of any one of the forty fifth to fifty second aspects, further comprising: separating at least a portion of hydrogen from the first product stream prior to reacting the carbon oxides in the second reactor.

A fifty fourth aspect can include the process of any one of the forty fifth to fifty third aspects, further comprising: splitting a portion of the second reactor products and recycling them to the second reactor.

A fifty fifth aspect can include the process of any one of the forty fifth to fifty fourth aspects, wherein the reacting of the first product stream in the second reactor occurs in the presence of a solid catalyst.

A fifty sixth aspect can include the process of the fifty fifth aspect, wherein the solid catalyst comprises an element of Group VI, Group VII, Group VIII, Group IX, or Group X, an actinide, a lanthanide, carbon, oxides thereof, alloys thereof, or combinations thereof.

A fifty seventh aspect can include the process of any one of the forty fifth to fifty sixth aspects, wherein the reacting in the second reactor occurs autothermally or exothermically.

A fifty eighth aspect can include the process of any one of the forty fifth to fifty seventh aspects, wherein the reacting of the carbon oxides in the second reactor produces a product gas stream comprising hydrogen, carbon oxides, and water, wherein the process further comprises: reacting the product gas stream in a water gas shift reactor to convert at least a portion of the carbon monoxide and water to carbon dioxide and hydrogen.

A fifty ninth aspect can include the process of any one of the forty fifth to fifty eighth aspects, wherein the reacting of the carbon oxides in the second reactor produces a product gas stream comprising hydrogen, carbon oxides, and water, wherein the process further comprises: reacting the product gas stream in a reverse water gas shift reactor to convert at least a portion of the carbon dioxide and hydrogen to carbon monoxide and water.

A sixtieth aspect can include the process of any one of the forty fifth to fifty ninth aspects, wherein the hydrocarbon comprises a light alkane, coal, biomass, an alcohol, naphtha, crude oil, or any combination thereof.

A sixty first aspect can include the process of the forty fifth aspect, wherein the hydrocarbon comprises methane, wherein the one or more oxygen-containing species comprise oxygen and carbon dioxide, wherein the carbon oxides comprise carbon monoxide and carbon dioxide, wherein the reacting of the carbon oxides in the second reactor occurs in the presence of a solid catalyst comprising iron and produces a solid product stream comprising solid carbon, and wherein the solid product stream further comprises iron oxides, iron, and iron carbide.

A sixty second aspect can include the process of the forty fifth aspect, wherein the hydrocarbon comprises biomass, wherein the one or more oxygen-containing species comprise oxygen and carbon dioxide, wherein the carbon oxides comprise carbon monoxide and carbon dioxide, wherein the reacting of the carbon oxides in the second reactor occurs in the presence of a solid catalyst comprising iron and produces a solid product stream comprising the solid carbon, and wherein the solid product stream further comprises iron oxides, iron, and iron carbide.

A sixty third aspect can include the process of any one of the forty fifth to sixty second aspects, wherein the process is free from CO₂ emissions.

In a sixty fourth aspect, a reaction process for producing hydrogen and carbon comprises: introducing a feed stream comprising a hydrocarbon and an oxidant into a reactor system, wherein the reactor system comprises one or more reactors; producing H₂ and solid carbon as products in the reactor system; separating the solid carbon and the H₂ from the one or more reactors; and recycling at least a portion of any unreacted hydrocarbon and the oxidant to an inlet of the reactor system.

A sixty fifth aspect can include the process of the sixty fourth aspect, wherein at least one reactor of the one or more reactors comprises a catalyst.

A sixty sixth aspect can include the process of the sixty fifth aspect, wherein producing the solid carbon uses the catalyst to catalytically produce the solid carbon.

A sixty seventh aspect can include the process of the sixty fifth or fifty sixth aspect, further comprising: continuously adding the catalyst to the reactor system; and continuously removing the solid carbon from the reactor system, wherein the solid carbon is disposed on a portion of the catalyst.

A sixty eighth aspect can include the process of any one of the sixty fourth to sixty seventh aspects, further comprising: producing water as a product in the reaction system, wherein the oxidant leaves the reactor system as water

A sixty ninth aspect can include the process of any one of the sixty fourth to sixty eighth aspects, wherein an outlet stream from the reactor system is free of or substantially free of carbon dioxide.

A seventieth aspect can include the process of any one of the sixty fourth to sixty ninth aspects, wherein the oxidant comprises at least one of CO₂, CO, O₂, or H₂O.

A seventy first aspect can include the process of any one of the sixty fourth to seventieth aspects, wherein the hydrocarbon comprises methane, ethane, natural gas, an alcohol, crude oil, biomass, naphtha, or a solid hydrocarbon.

A seventy second aspect can include the process of any one of the sixty fourth to seventy first aspects, wherein the reactor system operates autothermally or exothermically.

A seventy third aspect can include the process of any one of the sixty fourth to seventy second aspects, wherein the reactor system comprises a catalyst, wherein the catalyst comprises iron, where the oxidant comprises O₂, H₂O, and CO₂, wherein the hydrocarbon comprises methane.

A seventy fourth aspect can include the process of any one of the sixty fourth to seventy third aspects, further comprising: separating at least a portion of the oxidant and a portion of any unreacted hydrocarbons in a product stream; and recycling the portion of the oxidant and the portion of any unreacted hydrocarbons to an inlet of the reactor system.

In a seventy fifth aspect, a system for producing hydrogen and carbon comprises: one or more reactors; a feed stream comprising a hydrocarbon; an oxidant; a solid carbon product; and a hydrogen gas product, wherein the reactor is configured to receive the feed stream and the oxidant, and react the hydrocarbon and the oxidant to produce the solid carbon product and the hydrogen gas product.

A seventy sixth aspect can include the system of the seventy fifth aspect, wherein at least one reactor of the one or more reactors comprises a catalyst.

A seventy seventh aspect can include the system of the seventy fifth or seventy sixth aspect, further comprising: a water product, wherein the system is configured to convert the oxidant into water.

A seventy eighth aspect can include the system of any one of the seventy fifth to seventy seventh aspects, wherein the oxidant comprises at least one of CO₂, CO, O₂, or H₂O.

A seventy ninth aspect can include the system of any one of the seventy fifth to seventy eighth aspects, wherein the hydrocarbon comprises methane, ethane, natural gas, an alcohol, crude oil, biomass, naphtha, or a solid hydrocarbon.

An eightieth aspect can include the system of any one of the seventy fifth to seventy ninth aspects, wherein the one or more reactors are configured to operate autothermally or exothermically.

An eighty first aspect can include the system of any one of the seventy fifth to eightieth aspects, wherein the one or more reactors comprises a catalyst, wherein the catalyst comprises iron, where the oxidant comprises O₂, H₂O, and CO₂, wherein the hydrocarbon comprises methane.

An eighty second aspect can include the system of any one of the seventy fifth to eighty first aspects, further comprising: a recycle system comprising a separator and a recycle line, wherein the separator is configured to separate at least a portion of the oxidant and a portion of any unreacted hydrocarbons in a product stream and recycle the portion of the oxidant and the portion of any unreacted hydrocarbons to an inlet of the one or more reactors.

In an eighty third aspect, a process for the reaction of carbon monoxide and hydrogen comprises: reacting a feed stream in contact with a solid phase comprising catalyst and carbon in a reactor to produce a product stream comprising hydrogen, carbon monoxide, carbon dioxide, water, and solid carbon, wherein the feed stream comprises carbon monoxide and hydrogen; separating a solids stream comprising catalyst and carbon from the product stream to produce a gas stream comprising hydrogen, carbon monoxide, carbon dioxide, and water; cooling the gas stream in a heat exchanger; and separating water from the gas stream after the cooling to produce a dehydrated stream comprising hydrogen, carbon monoxide, and carbon dioxide.

An eighty fourth aspect can include the process of the eighty third aspect, wherein carbon dioxide is separated from the dehydrated stream to produce a separated stream comprising hydrogen and carbon monoxide.

An eighty fifth aspect can include the process of the eighty third or eighty fourth aspect, wherein the feed stream further comprises a hydrocarbon.

An eighty sixth aspect can include the process of any one of the eighty third to eighty fifth aspects, wherein the feed stream further comprises carbon dioxide.

An eighty seventh aspect can include the process of any one of the eighty third to eighty sixth aspects, wherein a catalyst stream comprising catalyst is added to the reactor.

An eighty eighth aspect can include the process of any one of the eighty third to eighty seventh aspects, wherein a portion of the solid phase in the reactor is removed from the reactor mostly by gravitational forces.

An eighty ninth aspect can include the process of any one of the eighty third to eighty eighth aspects, wherein the feed stream is heated in a heat exchanger prior to being reacted in the reactor.

A ninetieth aspect can include the process of any one of the eighty third to eighty ninth aspects, wherein cooling the gas stream comprises: cooling the gas stream with the feed stream in a heat exchanger to recover heat.

A ninety first aspect can include the process of any one of the eighty fourth to ninetieth aspects, wherein hydrogen is separated from the separated stream to form a first stream comprising hydrogen and a second stream comprising carbon monoxide.

A ninety second aspect can include the process of any one of the eighty third to ninetieth aspects, wherein hydrogen is separated from the dehydrated stream to form a first stream comprising hydrogen and a second stream comprising carbon monoxide and carbon dioxide.

A ninety third aspect can include the process of the ninety first or ninety second aspect, wherein a portion of the second stream is purged from the process to atmosphere to prevent buildup of inert gases, and wherein the portion of the second stream is less than 15% of the second stream by volume.

A ninety fourth aspect can include the process of any one of the eighty third to ninety third aspects, wherein any of the gas, the dehydrated, or the separated stream have further solids removed through a filtration-based solids separation.

A ninety fifth aspect can include the process of any one of the eighty third to ninety fourth aspects, wherein the gas stream is cooled by a steam boiler, a steam superheater, or another heat exchanger either before or after the gas stream is cooled by the heat exchanger.

A ninety sixth aspect can include the process of any one of the eighty fourth to ninety fifth aspects, wherein a portion of the separated stream called the recycle stream is recycled and combined with the feed stream, and wherein the recycle stream is between 20% and 95% by volume of the separated stream volumetric gas flow rate.

A ninety seventh aspect can include the process of any one of the eighty fourth to ninety fifth aspects, wherein a portion of the separated stream called the recycle stream is recycled and combined with the feed stream, and wherein the recycle stream is between 50% and 90% by volume of the separated stream volumetric gas flow rate.

A ninety eighth aspect can include the process of any one of the eighty third to ninety fifth aspects, wherein a portion of the dehydrated stream called the recycle stream is recycled and combined with the feed stream, and wherein the recycle stream is between 20% and 95% by volume of the dehydrated stream volumetric gas flow rate.

A ninety ninth aspect can include the process of any one of the eighty third to ninety fifth aspects, wherein a portion of the dehydrated stream called the recycle stream is recycled and combined with the feed stream, and wherein the recycle stream is between 50% and 90% by volume of the dehydrated stream volumetric gas flow rate.

A one hundredth aspect can include the process of any one of the eighty third to ninety ninth aspects, wherein the solid catalyst in the reactor comprises iron in its metallic form, an iron oxide, an iron carbide, or any combination thereof.

A one hundred first aspect can include the process of any one of the eighty third to one hundredth aspects, wherein the carbon to catalyst ratio in the solids stream is between 5:1 and 50:1 by mass.

A one hundred second aspect can include the process of any one of the eighty third to one hundred first aspects, wherein the carbon to catalyst ratio in the solids stream is between 2:1 and 200:1 by mass.

A one hundred third aspect can include the process of any one of the eighty third to one hundred second aspects, further comprising: cooling the reactor during the reacting.

A one hundred fourth aspect can include the process of the one hundred third aspect, wherein cooling the reactor comprises cooling the reactor using liquid water, boiling water, or superheating steam.

A one hundred fifth aspect can include the process of the one hundred third aspect, wherein cooling the reactor comprises cooling the reactor using endothermic reforming reactions which convert a hydrocarbon stream comprising a hydrocarbon to a syngas stream comprising carbon monoxide and hydrogen.

A one hundred sixth aspect can include the process of any one of the eighty third to one hundred fifth aspects, wherein the carbon monoxide conversion in the reactor from the feed stream to the product stream is between 20% and 60%.

A one hundred seventh aspect can include the process of any one of the eighty third to one hundred sixth aspects, wherein the carbon dioxide conversion in the reactor from the feed stream to the product stream is between 20% and 70%.

A one hundred eighth aspect can include the process of any one of the eighty third to one hundred seventh aspects, wherein the hydrogen conversion in the reactor from the feed stream to the product stream is between 5% and 30%.

A one hundred ninth aspect can include the process of any one of the eighty fourth to one hundred eighth aspects, wherein the hydrocarbon amount in the feed stream is at least about 10% by volume.

A one hundred tenth aspect can include the process of any one of the eighty third to one hundred ninth aspects, wherein the hydrogen to carbon monoxide ratio by volume in the feed stream is between about 0.25 and about 6.

A one hundred eleventh aspect can include the process of any one of the eighty third to one hundred tenth aspects, wherein the reactor is operated at a temperature between about 650° C. and about 800° C.

A one hundred twelfth aspect can include the process of any one of the eighty third to one hundred eleventh aspects, wherein the reactor is operated at a temperature between about 500° C. and about 900° C.

A one hundred thirteenth aspect can include the process of any one of the eighty third to one hundred twelfth aspects, wherein the reactor is operated at a pressure between about 5 bar absolute and about 15 bar absolute.

A one hundred fourteenth aspect can include the process of any one of the eighty third to one hundred thirteenth aspects, wherein the reactor is operated at a pressure between about 1 bar absolute and about 40 bar absolute.

A one hundred fifteenth aspect can include the process of any one of the eighty third to one hundred fourteenth aspects, wherein the total conversion of all gaseous species in the reactor from the feed stream to the product stream is between about 10% and about 50%, and wherein a molar flow rate of the gas stream is between about 90% and about 50% of the molar flow rate for the feed stream.

A one hundred sixteenth aspect can include the process of any one of the eighty third to one hundred fifteenth aspects, wherein the process is free of or substantially free of direct CO₂ emissions.

In a one hundred seventeenth aspect, a multiphase reaction system comprises: a feed stream comprising hydrogen, carbon monoxide, and methane that are reacted to a gas stream comprising hydrogen, carbon monoxide, carbon dioxide, and methane; and a solid phase comprising carbon and a catalyst.

A one hundred eighteenth aspect can include the system of the one hundred seventeenth aspect, wherein a solid phase catalyst stream comprising catalyst is added to the reaction system and a solid phase product stream comprising catalyst and carbon is removed from the reaction system in a continuous, semi-batch, or batch manner.

A one hundred nineteenth aspect can include the system of the one hundred eighteenth aspect, wherein the product stream is greater than 50% carbon by weight.

A one hundred twentieth aspect can include the system of any one of the one hundred seventeenth to one hundred nineteenth aspects, wherein the solid phase in the reaction system is less than 50% carbon by weight.

A one hundred twenty first aspect can include the system of any one of the one hundred seventeenth to one hundred twentieth aspects, wherein the reactor inner hydraulic diameter expands in the direction of gas flow.

A one hundred twenty second aspect can include the system of any one of the one hundred eighteenth to one hundred twenty first aspects, wherein the product stream is entrained from the system by way of its Sauter mean diameter being at least 2 times smaller than the solid phase.

A one hundred twenty third aspect can include the system of any one of the one hundred eighteenth to one hundred twenty second aspects, wherein a heavier stream comprising carbon and catalyst is removed from the system; and the heavier stream has a Sauter mean diameter at least 1.5 times the larger than the solid phase.

A one hundred twenty fourth aspect can include the system the one hundred twenty third aspect, wherein at least a portion of the heavier stream is removed from the system by gravitational forces.

A one hundred twenty fifth aspect can include the system of any one of the one hundred seventeenth to one hundred twenty fourth aspects, wherein at least 50% of the solid phase is fluidized by the feed stream.

A one hundred twenty sixth aspect can include the system of any one of the one hundred seventeenth to one hundred twenty fifth aspects, wherein the solid phase Sauter mean diameter is between 10 and 400 μm, or alternatively between 25 and 250 μm.

A one hundred twenty seventh aspect can include the system of any one of the one hundred eighteenth to one hundred twenty sixth aspects, wherein the catalyst stream Sauter mean diameter is between 50 and 500 μm, or alternatively between 100 and 300 μm.

A one hundred twenty eighth aspect can include the system of any one of the one hundred eighteenth to one hundred twenty seventh aspects, wherein the product stream Sauter mean diameter is between 0.01 and 100 μm, or alternatively between 0.1 and 10 μm.

A one hundred twenty ninth aspect can include the system of any one of the one hundred seventeenth to one hundred twenty eighth aspects, wherein the catalyst comprises Fe in its metallic, oxide, or carbide forms.

A one hundred thirtieth aspect can include the system of any one of the one hundred seventeenth to one hundred twenty ninth aspects, wherein the catalyst comprises Ni or Co in their metallic, oxide, or carbide forms.

A one hundred thirty first aspect can include the system of any one of the one hundred seventeenth to one hundred thirtieth aspects, wherein the catalyst comprises W, V, Mo, Ti, Ni, Ta, Zr, Cr, Hf in their metallic, oxide, or carbide forms.

A one hundred thirty second aspect can include the system of any one of the one hundred seventeenth to one hundred thirty first aspects, wherein the catalyst is unsupported.

A one hundred thirty third aspect can include the system of any one of the one hundred seventeenth to one hundred thirty second aspects, wherein a portion of the product stream is returned to the system in the catalyst stream.

A one hundred thirty fourth aspect can include the system of the one hundred thirty third aspect, wherein the portion of product stream returned in the catalyst stream has a larger Sauter mean diameter than the rest of the product stream.

A one hundred thirty fifth aspect can include the system of the one hundred thirty third or one hundred thirty fourth aspect, wherein the portion of product stream returned in the catalyst stream has a higher catalyst to C ratio by mass than the rest of the product stream.

A one hundred thirty sixth aspect can include the system of any one of the one hundred seventeenth to one hundred thirty fifth aspects, wherein the gas stream also comprises water.

A one hundred thirty seventh aspect can include the system of any one of the one hundred seventeenth to one hundred thirty sixth aspects, wherein the reactor temperature is between 65° and 800° C., or alternatively between 40° and 900° C.

A one hundred thirty eighth aspect can include the system of any one of the one hundred seventeenth to one hundred thirty seventh aspects, wherein the reactor pressure is between about 1 and 40 bar, or between about 1 and 20 bar absolute, or alternatively between 5 and 15 bar atmosphere.

A one hundred thirty ninth aspect can include the system of any one of the one hundred seventeenth to one hundred thirty eighth aspects, wherein the reactor is a fluidized bed or spouted bed.

A one hundred fortieth aspect can include the system of any one of the one hundred seventeenth to one hundred thirty ninth aspects, wherein the solid phase is configured to form a fluidized bed in a reactor with a solid phase comprising C, Fe, and Fe₃C that is less than 50% C by weight; and wherein the system further comprises a solid product stream that is entrained from the reactor, wherein the solid product stream comprises at least 50% C by weight and has a Sauter mean diameter at least 50% smaller than the solid phase in the reactor.

In a one hundred forty first aspect, a multiphase reaction process comprises: reacting a feed stream comprising hydrogen and carbon monoxide to form a gas stream comprising hydrogen, carbon monoxide, and carbon dioxide, wherein the reacting occurs in the presence of a catalyst in a reactor; and forming a solid phase comprising carbon on the catalyst.

A one hundred forty second aspect can include the process of the one hundred forty first aspect, further comprising: adding a solid phase catalyst stream comprising catalyst to the reactor during the reacting; and removing a solid phase product stream comprising carbon and catalyst from the reactor in a continuous, semi-batch, or batch manner.

A one hundred forty third aspect can include the process of the one hundred forty first or one hundred forty second aspect, wherein the product stream is greater than 50% carbon by weight.

A one hundred forty fourth aspect can include the process of any one of the one hundred forty first to one hundred forty third aspects, wherein the solid phase in the reaction system is less than 50% carbon by weight.

A one hundred forty fifth aspect can include the process of any one of the one hundred forty first to one hundred forty fourth aspects, wherein the reactor inner hydraulic diameter increases in the direction of gas flow.

A one hundred forty sixth aspect can include the process of any one of the one hundred forty first to one hundred forty fifth aspects, wherein the product stream is entrained from the system by way of its Sauter mean diameter being at least 2 times smaller than the solid phase in the reactor.

A one hundred forty seventh aspect can include the process of any one of the one hundred forty first to one hundred forty sixth aspects, wherein a heavier stream comprising carbon and catalyst is removed from the system and the heavier stream has a Sauter mean diameter at least 1.5 times the larger than the solid phase.

A one hundred forty eighth aspect can include the process of the one hundred forty seventh aspect, wherein at least a portion of the heavier stream is removed from the system by gravitational forces.

A one hundred forty ninth aspect can include the process of any one of the one hundred forty first to one hundred forty eighth aspects, wherein at least 50% of the solid phase in the reactor is fluidized by the feed stream.

A one hundred fiftieth aspect can include the process of any one of the one hundred forty first to one hundred forty ninth aspects, wherein the solid phase in the reactor has a Sauter mean diameter between 10 and 400 μm, or alternatively between 25 and 250 μm.

A one hundred fifty first aspect can include the process of any one of the one hundred forty first to one hundred fiftieth aspects, wherein the catalyst stream Sauter mean diameter is between 50 and 500 μm, or alternatively between 100 and 300 μm.

A one hundred fifty second aspect can include the process of any one of the one hundred forty first to one hundred fifty first aspects, wherein the product stream Sauter mean diameter is between 0.01 and 100 μm, or alternatively between 0.1 and 10 μm.

A one hundred fifty third aspect can include the process of any one of the one hundred forty first to one hundred fifty second aspects, wherein the catalyst comprises Fe in its metallic, oxide, or carbide forms.

A one hundred fifty fourth aspect can include the process of any one of the one hundred forty first to one hundred fifty third aspects, wherein the catalyst comprises Ni or Co in their metallic, oxide, or carbide forms.

A one hundred fifty fifth aspect can include the process of any one of the one hundred forty first to one hundred fifty fourth aspects, wherein the catalyst comprises W, V, Mo, Ti, Ni, Ta, Zr, Cr, Hf in their metallic, oxide, or carbide forms.

A one hundred fifty sixth aspect can include the process of any one of the one hundred forty first to one hundred fifty fifth aspects, wherein the catalyst is unsupported.

A one hundred fifty seventh aspect can include the process of any one of the one hundred forty first to one hundred fifty sixth aspects, wherein a portion of the product stream is returned to the reactor in the catalyst stream.

A one hundred fifty eighth aspect can include the process of the one hundred fifty seventh aspect, wherein the portion of product stream returned in the catalyst stream has a larger Sauter mean diameter than the rest of the product stream.

A one hundred fifty ninth aspect can include the process of the one hundred fifty seventh or one hundred fifty eighth aspect, wherein the portion of product stream returned in the catalyst stream has a higher catalyst to C ratio by mass than the rest of the product stream.

A one hundred sixtieth aspect can include the process of any one of the one hundred forty first to one hundred fifty ninth aspects, wherein the gas stream also comprises methane and water.

A one hundred sixty first aspect can include the process of any one of the one hundred forty first to one hundred sixtieth aspects, wherein the reactor temperature is between 650° C. and 800° C., or alternatively between 400° C. and 900° C.

A one hundred sixty second aspect can include the process of any one of the one hundred forty first to one hundred sixty first aspects, wherein the reactor pressure is between about 1 and about 40 bar, or between about 1 and 20 bar absolute, or alternatively between 5 and 15 bar atmosphere.

A one hundred sixty third aspect can include the process of any one of the one hundred forty first to one hundred sixty second aspects, wherein the reactor is a fluidized bed or spouted bed.

A one hundred sixty fourth aspect can include the process of any one of the one hundred forty first to one hundred sixty third aspects, wherein the solid phase is configured to form a fluidized bed in a reactor with a solid phase comprising C, Fe, and Fe₃C that is less than 50% C by weight; and wherein the system further comprises a solid product stream that is entrained from the reactor, wherein the solid product stream comprises at least 50% C by weight and has a Sauter mean diameter at least 50% smaller than the solid phase in the reactor.

It is to be further understood that the present description is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present systems and methods. It must be noted that as used herein and in the appended claims (in this application, or any derived applications thereof), the singular forms “a,” “an,” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this description belongs. Preferred methods, techniques, devices, and materials are described, although any methods, techniques, devices, or materials similar or equivalent to those described herein may be used in the practice or testing of the present systems and methods. Structures described herein are to be understood also to refer to functional equivalents of such structures. The present systems and methods will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims may be formulated in this Application or of any further Application derived therefrom, to particular combinations of features, it should be understood that the scope of the disclosure also includes any novel feature or any novel combination of features disclosed herein either explicitly or implicitly or any generalization thereof, whether or not it relates to the same systems or methods as presently claimed in any Claim and whether or not it mitigates any or all of the same technical problems as do the present systems and methods.

Features which are described in the context of separate embodiments may also be provided in combination in a single embodiment. Conversely, various features which are, for brevity, described in the context of a single embodiment, may also be provided separately or in any suitable sub-combination. The Applicants hereby give notice that new claims may be formulated to such features and/or combinations of such features during the prosecution of the present Application or of any further Application derived therefrom.

1.-7. (canceled)

8. A process for reacting of a hydrocarbon, the process comprising:
reacting a hydrocarbon with one or more oxygen-containing species in a first reactor to produce a first product stream comprising hydrogen, water, and carbon oxides;
separating water from the first product stream;
reacting the hydrogen and carbon oxides in a second reactor to produce a second product stream of solid carbon, water, hydrogen, and carbon oxides;
separating the solid carbon from the hydrogen, water, and carbon oxides; and
separating the water from the hydrogen and carbon oxides.

9. The process of claim 8, wherein the carbon oxides comprise carbon monoxide and carbon dioxide, where the process further comprises:
separating hydrogen from the second product stream to produce a third product stream of mostly carbon oxides; and
recycling the third product stream of mostly carbon oxides to the first reactor to react with the hydrocarbon.

10. The process of claim 8, wherein carbon monoxide is separated from the second product stream; and
recycling the carbon monoxide to the second reactor.

11. The process of claim 10, wherein hydrocarbon is present in at least one of the first product stream, the second product stream, or the third product stream, wherein the process further comprises separating and recycling the hydrocarbon to the first reactor, the second reactor, or both.

12. The process of claim 8, wherein reacting the hydrocarbons with the one or more oxygen-containing species in the first reactor comprises:
reacting the hydrocarbon with carbon dioxide.

13. The process of claim 12, wherein the reacting of the hydrocarbon occurs in the substantial absence of water.

14. The process of claim 8, wherein reacting the hydrocarbon with the one or more oxygen-containing species in the first reactor comprises:
reacting the hydrocarbon with water to produce carbon monoxide and hydrogen.

15. The process of claim 8, wherein reacting the hydrocarbon with the one or more oxygen-containing species in the first reactor comprises:
introducing oxygen into the first reactor with the hydrocarbon.

16. The process of claim 8, further comprising:
separating at least a portion of hydrogen from the first product stream prior to reacting the carbon oxides in the second reactor.

17. The process of claim 8, further comprising:
splitting a portion of the second reactor products and recycling them to the second reactor.

18. The process of claim 8, wherein the reacting of the first product stream in the second reactor occurs in the presence of a solid catalyst, and wherein the solid catalyst comprises an element of Group VI, Group VII, Group VIII, Group IX, Group X, an actinide, a lanthanide, carbon, oxides thereof, alloys thereof, or combinations thereof.

19. The process of claim 8, wherein the reacting in the second reactor occurs autothermally or exothermically.

20. The process of claim 8, wherein the reacting of the carbon oxides in the second reactor produces a product gas stream comprising hydrogen, carbon oxides, and water, wherein the process further comprises:
reacting the product gas stream in a water gas shift reactor to convert at least a portion of carbon monoxide and water to carbon dioxide and hydrogen.

21. The process of claim 8, wherein the reacting of the carbon oxides in the second reactor produces a product gas stream comprising hydrogen, carbon oxides, and water, wherein the process further comprises:
reacting the product gas stream in a reverse water gas shift reactor to convert at least a portion of carbon dioxide and hydrogen to carbon monoxide and water.

22. The process of claim 8, wherein the hydrocarbon comprises a light alkane, coal, biomass, an alcohol, naphtha, crude oil, or any combination thereof.

23. The process of claim 8, wherein the hydrocarbon comprises methane, wherein the one or more oxygen-containing species comprise oxygen, steam, and carbon dioxide, wherein the carbon oxides comprise carbon monoxide and carbon dioxide, wherein the reacting of the carbon oxides in the second reactor occurs in the presence of a solid catalyst comprising iron and produces a solid product stream comprising solid carbon, and wherein the solid product stream further comprises iron oxides, iron, and iron carbide.

24. (canceled)

25. A reaction process for producing hydrogen and carbon, the process comprising:
introducing a feed stream comprising a hydrocarbon and an oxidant into a reactor system, wherein the reactor system comprises one or more reactors;
producing H₂ and solid carbon as products in the reactor system;
separating the solid carbon and the H₂ from the one or more reactors; and
recycling at least a portion of any unreacted hydrocarbon and the oxidant to an inlet of the reactor system.

26. The process of claim 25, wherein at least one reactor of the one or more reactors comprises a catalyst.

27. The process of claim 25, wherein producing the solid carbon uses a catalyst to catalytically produce the solid carbon.

28. The process of claim 25, further comprising:
continuously adding a catalyst to the reactor system; and
continuously removing the solid carbon from the reactor system, wherein the solid carbon is disposed on a portion of the catalyst.

29. The process of claim 25, further comprising:
producing water as a product in the reactor system, wherein the oxidant leaves the reactor system as water.

30. The process of claim 25, wherein an outlet stream from the reactor system is free of or substantially free of carbon dioxide.

31. The process of claim 25, wherein the oxidant comprises at least one of CO₂, CO, O₂, or H₂O.

32. The process of claim 25, wherein the hydrocarbon comprises methane, ethane, natural gas, an alcohol, crude oil, biomass, naphtha, or a solid hydrocarbon.

33. The process of claim 25, wherein the reactor system comprises a catalyst, wherein the catalyst comprises iron, where the oxidant comprises O₂, H₂O, and CO₂, wherein the hydrocarbon comprises methane.

34. The process of claim 25, further comprising:
separating at least a portion of the oxidant and a portion of any unreacted hydrocarbons in a product stream; and
recycling the portion of the oxidant and the portion of any unreacted hydrocarbons to an inlet of the reactor system.

35.-89. (canceled)
